(19) United States
(12) Patent Application Publication
(10) Pub. No.: US 2024/0406666 A1
(43) Pub. Date: Dec. 5, 2024

(54) SOUND FIELD CAPTURE WITH HEADPOSE COMPENSATION

(71) Applicant: Magic Leap, Inc., Plantation, FL (US)

(72) Inventors: Remi Samuel AUDFRAY, San Francisco, CA (US); Jean-Marc JOT, Aptos, CA (US); David Thomas ROACH, Plantation, FL (US)

(21) Appl. No.: 18/697,914

(22) PCT Filed: Oct. 3, 2022
(86) PCT No.: PCT/US2022/077487

§ 371 Date: Apr. 2, 2024

Related U.S. Application Data
(60) Provisional application No. 63/252,391, filed on Oct. 5, 2021.

(51) Int. Cl. H04S 7/00

(52) U.S. Cl. CPC H04S 7/304; H04S 2400/11; H04S 2400/15; H04S 2420/11

(57) ABSTRACT

Disclosed herein are systems and methods for capturing a sound field, in particular, using a mixed reality device. In some embodiments, a method comprises: detecting, with a microphone of a first wearable-head device, a sound of an environment; determining a digital audio signal based on the detected sound, the digital audio signal associated with a sphere having a position in the environment; concurrently with detecting the sound, a microphone movement with respect to the environment; adjusting the digital audio signal, wherein the adjusting comprises adjusting the position of the sphere based on based on the detected microphone movement.

### CROSS-REFERENCE TO RELATED APPLICATIONS

This application claims priority to U.S. Provisional Application No. 63/252,391, filed on Oct. 5, 2021, the contents of which are incorporated by reference herein in their entirety.

### FIELD

This disclosure relates in general to systems and methods for capturing a sound field and sound field playback, in particular, using a mixed reality device.

### BACKGROUND

It may be desirable to capture a sound field (e.g., recording a multidimensional audio scene) using an augmented reality (AR), mixed reality (MR), or extended reality (XR) device (e.g., a wearable head device). For example, it may be advantageous to use a wearable head device to record a 3-D audio scene surrounding a user of the device (e.g., to create AR, MR, or XR content without additional (and often more expensive) sound recording equipment, to create AR, MR, or XR content in a first person point of view). However, while recording the audio scene, the recording device may not be fixed. For instance, while recording, the user may move his or her head, thereby moving the recording device. The recording device movement may cause the recorded sound field and playback of the sound field to be disoriented. To ensure proper sound field orientation (e.g., to properly align with an AR, MR, or XR environment), it may be desirable to compensate for these movements in the sound field capture. Similarly, it may also be desirable to compensate for movements of a playback device during sound field playback to fix a sound source while a playback device moves relative to the AR, MR, or XR environment.

In some examples, the sound field or 3-D audio scene may be a part of AR/MR/XR content that supports six degrees of freedom for a user accessing the AR/MR/XR content. An entire sound field or 3-D audio scene that supports six degrees of freedom may result in very large and/or complex files, which would require more computing resources to access. Therefore, it may be desirable to reduce the complexity of such sound field or 3-D audio scene.

### BRIEF SUMMARY

Examples of the disclosure describe systems and methods for capturing a sound field, in particular and sound field playback, using a mixed reality device. In some embodiments, the systems and methods compensate for movement of a recording device while capturing a sound field. In some embodiments, the systems and methods compensate for movement of a playback device while playing an audio of a sound field. In some embodiments, the systems and methods reduce a complexity of a captured sound field.

In some embodiments, a method comprises: detecting, with a microphone of a first wearable head device, a sound of an environment; determining a digital audio signal based on the detected sound, the digital audio signal associated with a sphere having a position in the environment; concurrently with detecting the sound, detecting, via a sensor of the first wearable head device, a microphone movement with respect to the environment; adjusting the digital audio signal, wherein the adjusting comprises adjusting the position of the sphere based on based on the detected microphone movement; and presenting the adjusted digital audio signal to a user of a second wearable head device via one or more speakers of the second wearable head device.

In some embodiments, the method further comprises: detecting, with a microphone of a third wearable head device, a second sound of the environment; determining a second digital audio signal based on the second detected sound, the second digital audio signal associated with a second sphere having a second position in the environment; concurrently, with detecting the second sound, detecting, via a sensor of the third wearable head device, a microphone movement with respect to the environment; adjusting the second digital audio signal, wherein the adjusting comprises adjusting the second position of the second sphere based on based on the second detected microphone movement; combining the adjusted digital audio signal and the second adjusted digital audio signal; and presenting the combined first adjusted digital audio signal and second adjusted digital audio signal to the user of the second wearable head device via the one or more speakers of the second wearable head device.

In some embodiments, the first adjusted digital audio signal and the second adjusted digital audio signal are combined at a server.

In some embodiments, the digital audio signal comprises an Ambisonic file.

In some embodiments, detecting the microphone movement with respect to the environment comprises one or more of performing simultaneous localization and mapping and visual inertial odometry.

In some embodiments, the sensor comprises one or more of an inertial measurement unit, a camera, a second microphone, a gyroscope, and a LiDAR sensor.

In some embodiments, adjusting the digital audio signal comprises applying a compensation function to the digital audio signal.

In some embodiments, wherein applying the compensation function comprises applying the compensation function based on an inverse of the microphone movement.

In some embodiments, the method further comprises concurrently, with presenting the adjusted digital audio signal, displaying, on a display of the second wearable head device, content associated with the sound of the environment.

In some embodiments, a method comprises: receiving, at a wearable head device, a digital audio signal, the digital audio signal associated with a sphere having a position in the environment; detecting, via a sensor of the wearable head device, a device movement with respect to the environment; adjusting the digital audio signal, wherein the adjusting comprises adjusting the position of the sphere based on based on the detected device movement; and presenting the adjusted digital audio signal to a user of the wearable head device via one or more speakers of the wearable head device.

In some embodiments, the method further comprises: combining a second digital audio signal and a third digital audio signal; and downmixing the combined second and third digital audio signal, wherein the retrieved first digital audio signal is the combined second and third digital audio signal.

In some embodiments, downmixing the combined second and third digital audio signal comprises applying a first gain to the second digital audio signal and a second gain to the second digital audio signal.

In some embodiments, downmixing the combined second and third digital audio signal comprises reducing an Ambisonic order of the second digital audio signal based on a distance of the wearable head device from a recording location of the second digital audio signal.

In some embodiments, the sensor is an inertial measurement unit, a camera, a second microphone, a gyroscope, or a LiDAR sensor.

In some embodiments, detecting the device movement with respect to the environment comprises performing simultaneous localization and mapping or visual inertial odometry.

In some embodiments, adjusting the digital audio signal comprises applying a compensation function to the digital audio signal.

In some embodiments, wherein applying the compensation function comprises applying the compensation function based on an inverse of the microphone movement. In some embodiments, the digital audio signal is in Ambisonics format.

In some embodiments, the method further comprises concurrently, with presenting the adjusted digital audio signal, displaying, on a display of the wearable head device, content associated with a sound of the digital audio signal in the environment.

In some embodiments, a method comprises: detecting sounds of an environment; extracting a sound object from the detected sounds; and combining the sound object and a residual. The sound object comprises a first portion of the detected sounds, the first portion meeting a sound object criterion, and the residual comprises a second portion of the detected sounds, the second portion not meeting the sound object criterion.

In some embodiments, the further comprises: detecting second sounds of the environment; determining whether a portion of the second detected sounds meets the sound object criterion, wherein: a portion of the second detected sounds meeting the sound object criterion comprises a second sound object, and a portion of the second detected sounds not meeting the sound object criterion comprises a second residual; extracting the second sound object from the second detected sounds; and consolidating the first sound object and the second sound object, wherein combining the sound object and the residual comprises combining the consolidated sound object, the first residual, and the second residual.

In some embodiments, the sound object supports six degrees of freedom in the environment, and the residual supports three degrees of freedom in the environment.

In some embodiments, the sound object has a higher spatial resolution than the residual.

In some embodiments, the residual is stored in a lower order Ambisonic file.

In some embodiments, a method, comprises: detecting, via a sensor of a wearable head device, a movement of the wearable head device with respect to the environment; adjusting a sound object, wherein the sound object is associated with a first sphere having a first position in the environment and the adjusting comprises adjusting the first position of the first sphere based on based on the detected device movement; adjusting a residual, wherein the residual is associated with a second sphere having a second position in the environment and the adjusting comprises adjusting the second position of the second sphere based on based on the detected device movement; mixing the adjusted sound object and the adjusted residual; and presenting the mixed adjusted sound object and the adjusted residual to a user of the wearable head device via one or more speakers of the wearable head device.

In some embodiments, a system comprises: a first wearable head device comprising a microphone and a sensor; a second wearable head device comprising a speaker; and one or more processors configured to execute a method comprising: detecting, with the microphone of the first wearable head device, a sound of an environment; determining a digital audio signal based on the detected sound, the digital audio signal associated with a sphere having a position in the environment; concurrently with detecting the sound, detecting, via the sensor of the first wearable head device, a microphone movement with respect to the environment; adjusting the digital audio signal, wherein the adjusting comprises adjusting the position of the sphere based on based on the detected microphone movement; and presenting the adjusted digital audio signal to a user of the second wearable head device via the speaker of the second wearable head device.

In some embodiments, the system further comprises a third wearable head device comprising a microphone and a sensor, wherein the method further comprises: detecting, with the microphone of the third wearable head device, a second sound of the environment; determining a second digital audio signal based on the second detected sound, the second digital audio signal associated with a second sphere having a second position in the environment; concurrently, with detecting the second sound, detecting, via the sensor of the third wearable head device, a second microphone movement with respect to the environment; adjusting the second digital audio signal, wherein the adjusting comprises adjusting the second position of the second sphere based on based on the second detected microphone movement; combining the adjusted digital audio signal and the second adjusted digital audio signal; and presenting the combined first adjusted digital audio signal and second adjusted digital audio signal to the user of the second wearable head device via the one or more speakers of the second wearable head device.

In some embodiments, the first adjusted digital audio signal and the second adjusted digital audio signal are combined at a server.

In some embodiments, the digital audio signal comprises an Ambisonic file.

In some embodiments, detecting the microphone movement with respect to the environment comprises performing one or more of simultaneous localization and mapping and visual inertial odometry.

In some embodiments, the sensor comprises one or more of an inertial measurement unit, a camera, a second microphone, a gyroscope, and a LiDAR sensor.

In some embodiments, adjusting the digital audio signal comprises applying a compensation function to the digital audio signal.

In some embodiments, wherein applying the compensation function comprises applying the compensation function based on an inverse of the microphone movement.

In some embodiments, the method further comprises concurrently, with presenting the adjusted digital audio signal, displaying, on a display of the second wearable head device, content associated with the sound of the environment.

In some embodiments, a system comprises: a wearable head device comprising a sensor and a speaker; and one or more processors configured to execute a method comprising: receiving, at the wearable head device, a digital audio signal, the digital audio signal associated with a sphere having a position in the environment; detecting, via the sensor of the wearable head device, a device movement with respect to the environment; adjusting the digital audio signal, wherein the adjusting comprises adjusting the position of the sphere based on based on the detected device movement; and presenting the adjusted digital audio signal to a user of the wearable head device via the speaker of the wearable head device.

In some embodiments, the method further comprises: combining a second digital audio signal and a third digital audio signal; and downmixing the combined second and third digital audio signal, wherein the retrieved first digital audio signal is the combined second and third digital audio signal.

In some embodiments, downmixing the combined second and third digital audio signal comprises applying a first gain to the second digital audio signal and a second gain to the second digital audio signal.

In some embodiments, downmixing the combined second and third digital audio signal comprises reducing an Ambisonic order of the second digital audio signal based on a distance of the wearable head device from a recording location of the second digital audio signal.

In some embodiments, the sensor is an inertial measurement unit, a camera, a second microphone, a gyroscope, or a LiDAR sensor.

In some embodiments, detecting the device movement with respect to the environment comprises performing simultaneous localization and mapping or visual inertial odometry.

In some embodiments, adjusting the digital audio signal comprises applying a compensation function to the digital audio signal.

In some embodiments, wherein applying the compensation function comprises applying the compensation function based on an inverse of the microphone movement.

In some embodiments, the digital audio signal is in Ambisonics format.

In some embodiments, the wearable head device further comprises a display, and the method further comprises concurrently, with presenting the adjusted digital audio signal, displaying, on the display of the wearable head device, content associated with a sound of the digital audio signal in the environment.

In some embodiments, a system comprises one or more processors configured to execute a method comprising: detecting sounds of an environment; extracting a sound object from the detected sounds; and combining the sound object and a residual. The sound object comprises a first portion of the detected sounds, the first portion meeting a sound object criterion, and the residual comprises a second portion of the detected sounds, the second portion not meeting the sound object criterion.

In some embodiments, the method further comprises: detecting second sounds of the environment; determining whether a portion of the second detected sounds meets the sound object criterion, wherein: a portion of the second detected sounds meeting the sound object criterion comprises a second sound object, and a portion of the second detected sounds not meeting the sound object criterion comprises a second residual; extracting the second sound object from the second detected sounds; and consolidating the first sound object and the second sound object, wherein combining the sound object and the residual comprises combining the consolidated sound object, the first residual, and the second residual.

In some embodiments, the sound object supports six degrees of freedom in the environment, and the residual supports three degrees of freedom in the environment.

In some embodiments, the sound object has a higher spatial resolution than the residual.

In some embodiments, the residual is stored in a lower order Ambisonic file.

In some embodiments, a system comprises: a wearable head device comprising a sensor and a speaker; and one or more processors configured to execute a method comprising: detecting, via the sensor of the wearable head device, a movement of the wearable head device with respect to the environment; adjusting a sound object, wherein the sound object is associated with a first sphere having a first position in the environment and the adjusting comprises adjusting the first position of the first sphere based on based on the detected device movement; adjusting a residual, wherein the residual is associated with a second sphere having a second position in the environment and the adjusting comprises adjusting the second position of the second sphere based on based on the detected device movement; mixing the adjusted sound object and the adjusted residual; and presenting the mixed adjusted sound object and the adjusted residual to a user of the wearable head device via the speaker of the wearable head device.

In some embodiments, a non-transitory computer-readable medium stores one or more instructions, which, when executed by one or more processors of an electronic device, cause the device to perform a method comprising: detecting, with a microphone of a first wearable head device, a sound of an environment; determining a digital audio signal based on the detected sound, the digital audio signal associated with a sphere having a position in the environment; concurrently with detecting the sound, detecting, via a sensor of the first wearable head device, a microphone movement with respect to the environment; adjusting the digital audio signal, wherein the adjusting comprises adjusting the position of the sphere based on based on the detected microphone movement; and presenting the adjusted digital audio signal to a user of a second wearable head device via one or more speakers of the second wearable head device.

In some embodiments, the method further comprises: detecting, with a microphone of a third wearable head device, a second sound of the environment; determining a second digital audio signal based on the second detected sound, the second digital audio signal associated with a second sphere having a second position in the environment; concurrently, with detecting the second sound, detecting, via a sensor of the third wearable head device, a second microphone movement with respect to the environment; adjusting the second digital audio signal, wherein the adjusting comprises adjusting the second position of the second sphere based on based on the second detected microphone movement; combining the adjusted digital audio signal and the second adjusted digital audio signal; and presenting the combined first adjusted digital audio signal and second adjusted digital audio signal to the user of the second wearable head device via the one or more speakers of the second wearable head device.

In some embodiments, the first adjusted digital audio signal and the second adjusted digital audio signal are combined at a server.

In some embodiments, the digital audio signal comprises an Ambisonic file.

In some embodiments, detecting the microphone movement with respect to the environment comprises performing one or more of simultaneous localization and mapping and visual inertial odometry.

In some embodiments, the sensor comprises one or more of an inertial measurement unit, a camera, a second microphone, a gyroscope, and a LiDAR sensor.

In some embodiments, adjusting the digital audio signal comprises applying a compensation function to the digital audio signal.

In some embodiments, wherein applying the compensation function comprises applying the compensation function based on an inverse of the microphone movement.

In some embodiments, the method further comprises concurrently, with presenting the adjusted digital audio signal, displaying, on a display of the second wearable head device, content associated with the sound of the environment.

In some embodiments, a non-transitory computer-readable medium stores one or more instructions, which, when executed by one or more processors of an electronic device, cause the device to perform a method comprising: receiving, at a wearable head device, a digital audio signal, the digital audio signal associated with a sphere having a position in the environment; detecting, via a sensor of the wearable head device, a device movement with respect to the environment; adjusting the digital audio signal, wherein the adjusting comprises adjusting the position of the sphere based on based on the detected device movement; and presenting the adjusted digital audio signal to a user of the wearable head device via one or more speakers of the wearable head device.

In some embodiments, the method further comprises: combining a second digital audio signal and a third digital audio signal; and downmixing the combined second and third digital audio signal, wherein the retrieved first digital audio signal is the combined second and third digital audio signal.

In some embodiments, downmixing the combined second and third digital audio signal comprises applying a first gain to the second digital audio signal and a second gain to the second digital audio signal.

In some embodiments, downmixing the combined second and third digital audio signal comprises reducing an Ambisonic order of the second digital audio signal based on a distance of the wearable head device from a recording location of the second digital audio signal.

In some embodiments, the sensor is an inertial measurement unit, a camera, a second microphone, a gyroscope, or a LiDAR sensor.

In some embodiments, detecting the device movement with respect to the environment comprises performing simultaneous localization and mapping or visual inertial odometry.

In some embodiments, adjusting the digital audio signal comprises applying a compensation function to the digital audio signal.

In some embodiments, wherein applying the compensation function comprises applying the compensation function based on an inverse of the microphone movement.

In some embodiments, the digital audio signal is in Ambisonics format.

In some embodiments, the method further comprises concurrently, with presenting the adjusted digital audio signal, displaying, on a display of the wearable head device, content associated with a sound of the digital audio signal in the environment.

In some embodiments, a non-transitory computer-readable medium stores one or more instructions, which, when executed by one or more processors of an electronic device, cause the device to perform a method comprising: detecting sounds of an environment; extracting a sound object from the detected sounds; and combining the sound objects and a residual. The sound object comprises a first portion of the detected sounds, the first portion meeting a sound object criterion, and the residual comprises a second portion of the detected sounds, the second portion not meeting the sound object criterion.

In some embodiments, the method further comprises: detecting second sounds of the environment; determining whether a portion of the second detected sounds meets the sound object criterion, wherein: a portion of the second detected sounds meeting the sound object criterion comprises a second sound object, and a portion of the second detected sounds not meeting the sound object criterion comprises a second residual; extracting the second sound object from the second detected sounds; and consolidating the first sound object and the second sound object, wherein combining the sound object and the residual comprises combining the consolidated sound object, the first residual, and the second residual.

In some embodiments, the sound object supports six degrees of freedom in the environment, and the residual supports three degrees of freedom in the environment.

In some embodiments, the sound object has a higher spatial resolution than the residual.

In some embodiments, the residual is stored in a lower order Ambisonic file.

In some embodiments, a non-transitory computer-readable medium stores one or more instructions, which, when executed by one or more processors of an electronic device, cause the device to perform a method comprising: detecting, via a sensor of a wearable head device, a device movement with respect to the environment; adjusting a sound object, wherein the sound object is associated with a first sphere having a first position in the environment and the adjusting comprises adjusting the first position of the first sphere based on based on the detected device movement; adjusting a residual, wherein the residual is associated with a second sphere having a second position in the environment and the adjusting comprises adjusting the second position of the second sphere based on based on the detected device movement; mixing the adjusted sound object and the adjusted residual; and presenting the mixed adjusted sound object and adjusted residual to a user of the wearable head device via one or more speakers of the wearable head device.

### BRIEF DESCRIPTION OF THE DRAWINGS

FIGS. 1A-1C illustrate example environments according to some embodiments of the disclosure.

FIGS. 2A-2B illustrate example wearable systems according to some embodiments of the disclosure.

FIG. 3 illustrates an example handheld controller that can be used in conjunction with an example wearable system according to some embodiments of the disclosure.

FIG. 4 illustrates an example auxiliary unit that can be used in conjunction with an example wearable system according to some embodiments of the disclosure.

FIGS. 5A-5B illustrate example functional block diagrams for an example wearable system according to some embodiments of the disclosure.

FIG. 6A illustrates an exemplary method of capturing a sound field according to some embodiments of the disclosure.

FIG. 6B illustrates an exemplary method of playing an audio from a sound field according to some embodiments of the disclosure.

FIG. 7A illustrates an exemplary method of capturing a sound field according to some embodiments of the disclosure.

FIG. 7B illustrates an exemplary method of playing an audio from a sound field according to some embodiments of the disclosure.

FIG. 8A illustrates an exemplary method of capturing a sound field according to some embodiments of the disclosure.

FIG. 8B illustrates an exemplary method of playing an audio from a sound field according to some embodiments of the disclosure.

FIG. 9 illustrates an exemplary method of capturing a sound field according to some embodiments of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

Like all people, a user of a MR system exists in a real environment—that is, a three-dimensional portion of the “real world,” and all of its contents, that are perceptible by the user. For example, a user perceives a real environment using one's ordinary human senses—sight, sound, touch, taste, smell—and interacts with the real environment by moving one's own body in the real environment. Locations in a real environment can be described as coordinates in a coordinate space; for example, a coordinate can comprise latitude, longitude, and elevation with respect to sea level; distances in three orthogonal dimensions from a reference point; or other suitable values. Likewise, a vector can describe a quantity having a direction and a magnitude in the coordinate space.

A computing device can maintain, for example in a memory associated with the device, a representation of a virtual environment. As used herein, a virtual environment is a computational representation of a three-dimensional space. A virtual environment can include representations of any object, action, signal, parameter, coordinate, vector, or other characteristic associated with that space. In some examples, circuitry (e.g., a processor) of a computing device can maintain and update a state of a virtual environment; that is, a processor can determine at a first time t0, based on data associated with the virtual environment and/or input provided by a user, a state of the virtual environment at a second time t1. For instance, if an object in the virtual environment is located at a first coordinate at time t0, and has certain programmed physical parameters (e.g., mass, coefficient of friction); and an input received from user indicates that a force should be applied to the object in a direction vector; the processor can apply laws of kinematics to determine a location of the object at time t1 using basic mechanics. The processor can use any suitable information known about the virtual environment, and/or any suitable input, to determine a state of the virtual environment at a time t1. In maintaining and updating a state of a virtual environment, the processor can execute any suitable software, including software relating to the creation and deletion of virtual objects in the virtual environment; software (e.g., scripts) for defining behavior of virtual objects or characters in the virtual environment; software for defining the behavior of signals (e.g., audio signals) in the virtual environment; software for creating and updating parameters associated with the virtual environment; software for generating audio signals in the virtual environment; software for handling input and output; software for implementing network operations; software for applying asset data (e.g., animation data to move a virtual object over time); or many other possibilities.

Output devices, such as a display or a speaker, can present any or all aspects of a virtual environment to a user. For example, a virtual environment may include virtual objects (which may include representations of inanimate objects; people; animals; lights; etc.) that may be presented to a user. A processor can determine a view of the virtual environment (for example, corresponding to a “camera” with an origin coordinate, a view axis, and a frustum); and render, to a display, a viewable scene of the virtual environment corresponding to that view. Any suitable rendering technology may be used for this purpose. In some examples, the viewable scene may include some virtual objects in the virtual environment, and exclude certain other virtual objects. Similarly, a virtual environment may include audio aspects that may be presented to a user as one or more audio signals. For instance, a virtual object in the virtual environment may generate a sound originating from a location coordinate of the object (e.g., a virtual character may speak or cause a sound effect); or the virtual environment may be associated with musical cues or ambient sounds that may or may not be associated with a particular location. A processor can determine an audio signal corresponding to a “listener” coordinate—for instance, an audio signal corresponding to a composite of sounds in the virtual environment, and mixed and processed to simulate an audio signal that would be heard by a listener at the listener coordinate (e.g., using the methods and systems described herein)—and present the audio signal to a user via one or more speakers.

Because a virtual environment exists as a computational structure, a user may not directly perceive a virtual environment using one's ordinary senses. Instead, a user can perceive a virtual environment indirectly, as presented to the user, for example by a display, speakers, haptic output devices, etc. Similarly, a user may not directly touch, manipulate, or otherwise interact with a virtual environment; but can provide input data, via input devices or sensors, to a processor that can use the device or sensor data to update the virtual environment. For example, a camera sensor can provide optical data indicating that a user is trying to move an object in a virtual environment, and a processor can use that data to cause the object to respond accordingly in the virtual environment.

A MR system can present to the user, for example using a transmissive display and/or one or more speakers (which may, for example, be incorporated into a wearable head device), a MR environment (“MRE”) that combines aspects of a real environment and a virtual environment. In some embodiments, the one or more speakers may be external to the wearable head device. As used herein, a MRE is a simultaneous representation of a real environment and a corresponding virtual environment. In some examples, the corresponding real and virtual environments share a single coordinate space; in some examples, a real coordinate space and a corresponding virtual coordinate space are related to each other by a transformation matrix (or other suitable representation). Accordingly, a single coordinate (along with, in some examples, a transformation matrix) can define a first location in the real environment, and also a second, corresponding, location in the virtual environment; and vice versa.

In a MRE, a virtual object (e.g., in a virtual environment associated with the MRE) can correspond to a real object (e.g., in a real environment associated with the MRE). For instance, if the real environment of a MRE comprises a real lamp post (a real object) at a location coordinate, the virtual environment of the MRE may comprise a virtual lamp post (a virtual object) at a corresponding location coordinate. As used herein, the real object in combination with its corresponding virtual object together constitute a “mixed reality object.” It is not necessary for a virtual object to perfectly match or align with a corresponding real object. In some examples, a virtual object can be a simplified version of a corresponding real object. For instance, if a real environment includes a real lamp post, a corresponding virtual object may comprise a cylinder of roughly the same height and radius as the real lamp post (reflecting that lamp posts may be roughly cylindrical in shape). Simplifying virtual objects in this manner can allow computational efficiencies, and can simplify calculations to be performed on such virtual objects. Further, in some examples of a MRE, not all real objects in a real environment may be associated with a corresponding virtual object. Likewise, in some examples of a MRE, not all virtual objects in a virtual environment may be associated with a corresponding real object. That is, some virtual objects may solely in a virtual environment of a MRE, without any real-world counterpart.

In some examples, virtual objects may have characteristics that differ, sometimes drastically, from those of corresponding real objects. For instance, while a real environment in a MRE may comprise a green, two-armed cactus—a prickly inanimate object—a corresponding virtual object in the MRE may have the characteristics of a green, two-armed virtual character with human facial features and a surly demeanor. In this example, the virtual object resembles its corresponding real object in certain characteristics (color, number of arms); but differs from the real object in other characteristics (facial features, personality). In this way, virtual objects have the potential to represent real objects in a creative, abstract, exaggerated, or fanciful manner; or to impart behaviors (e.g., human personalities) to otherwise inanimate real objects. In some examples, virtual objects may be purely fanciful creations with no real-world counterpart (e.g., a virtual monster in a virtual environment, perhaps at a location corresponding to an empty space in a real environment).

In some examples, virtual objects may have characteristics that resemble corresponding real objects. For instance, a virtual character may be presented in a virtual or mixed reality environment as a life-like figure to provide a user an immersive mixed reality experience. With virtual characters having life-like characteristics, the user may feel like he or she is interacting with a real person. In such instances, it is desirable for actions such as muscle movements and gaze of the virtual character to appear natural. For example, movements of the virtual character should be similar to its corresponding real object (e.g., a virtual human should walk or move its arm like a real human). As another example, the gestures and positioning of the virtual human should appear natural, and the virtual human can initial interactions with the user (e.g., the virtual human can lead a collaborative experience with the user). Presentation of virtual characters or objects having life-like audio responses is described in more detail herein.

Compared to VR systems, which present the user with a virtual environment while obscuring the real environment, a mixed reality system presenting a MRE affords the advantage that the real environment remains perceptible while the virtual environment is presented. Accordingly, the user of the mixed reality system is able to use visual and audio cues associated with the real environment to experience and interact with the corresponding virtual environment. As an example, while a user of VR systems may struggle to perceive or interact with a virtual object displayed in a virtual environment—because, as noted herein, a user may not directly perceive or interact with a virtual environment—a user of an MR system may find it more intuitive and natural to interact with a virtual object by seeing, hearing, and touching a corresponding real object in his or her own real environment. This level of interactivity may heighten a user's feelings of immersion, connection, and engagement with a virtual environment. Similarly, by simultaneously presenting a real environment and a virtual environment, mixed reality systems may reduce negative psychological feelings (e.g., cognitive dissonance) and negative physical feelings (e.g., motion sickness) associated with VR systems. Mixed reality systems further offer many possibilities for applications that may augment or alter our experiences of the real world.

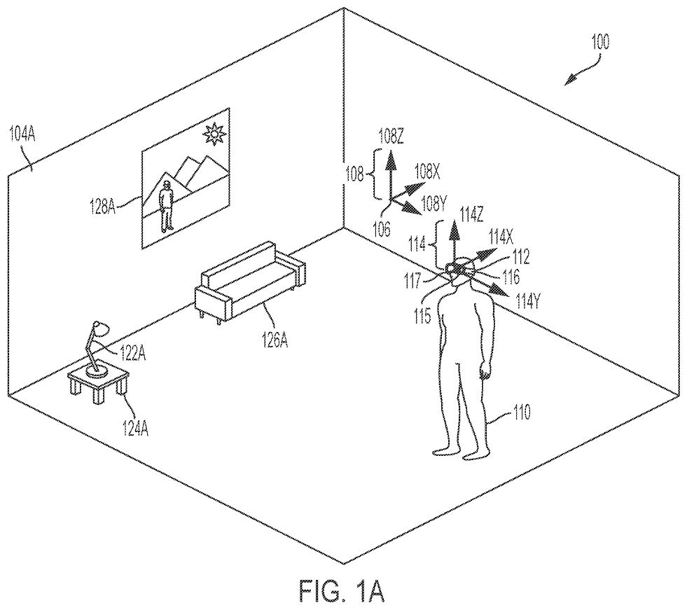

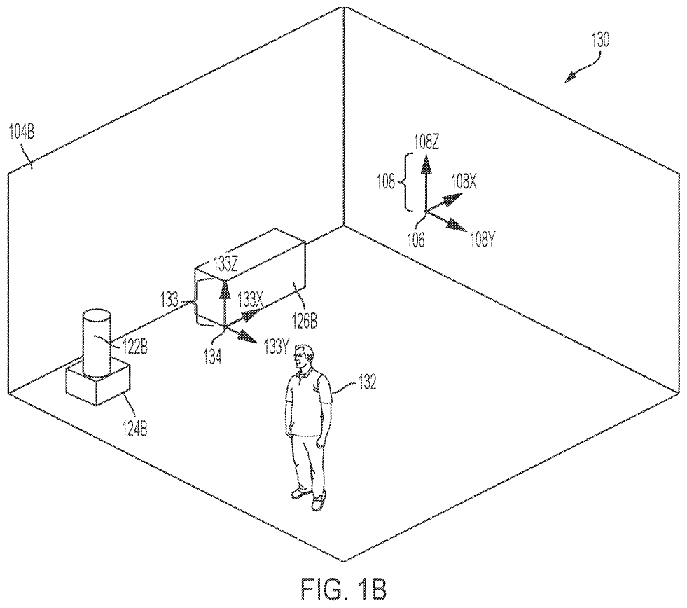

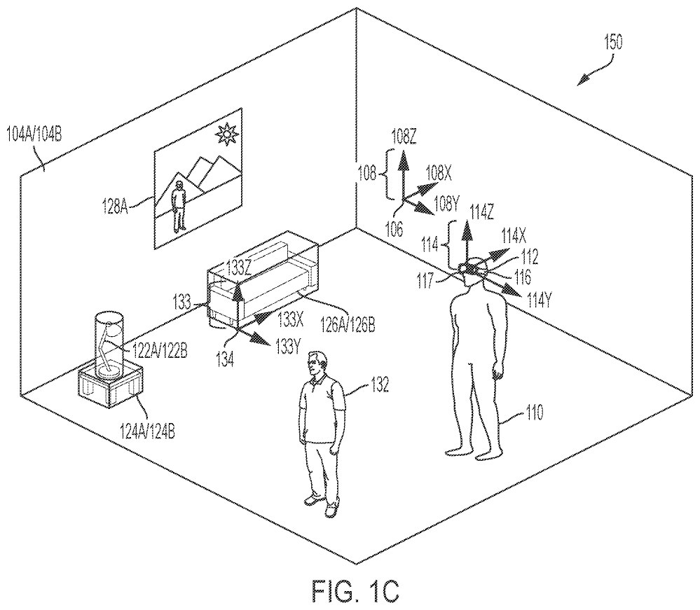

FIG. 1A illustrates an exemplary real environment 100 in which a user 110 uses a mixed reality system 112. Mixed reality system 112 may comprise a display (e.g., a transmissive display), one or more speakers, and one or more sensors (e.g., a camera), for example as described herein. The real environment 100 shown comprises a rectangular room 104A, in which user 110 is standing; and real objects 122A (a lamp), 124A (a table), 126A (a sofa), and 128A (a painting). Room 104A may be spatially described with a location coordinate (e.g., coordinate system 108); locations of the real environment 100 may be described with respect to an origin of the location coordinate (e.g., point 106). As shown in FIG. 1A, an environment/world coordinate system 108 (comprising an x-axis 108X, a y-axis 108Y, and a z-axis 108Z) with its origin at point 106 (a world coordinate), can define a coordinate space for real environment 100. In some embodiments, the origin point 106 of the environment/world coordinate system 108 may correspond to where the mixed reality system 112 was powered on. In some embodiments, the origin point 106 of the environment/world coordinate system 108 may be reset during operation. In some examples, user 110 may be considered a real object in real environment 100; similarly, user 110's body parts (e.g., hands, feet) may be considered real objects in real environment 100. In some examples, a user/listener/head coordinate system 114 (comprising an x-axis 114X, a y-axis 114Y, and a z-axis 114Z) with its origin at point 115 (e.g., user/listener/head coordinate) can define a coordinate space for the user/listener/head on which the mixed reality system 112 is located. The origin point 115 of the user/listener/head coordinate system 114 may be defined relative to one or more components of the mixed reality system 112. For example, the origin point 115 of the user/listener/head coordinate system 114 may be defined relative to the display of the mixed reality system 112 such as during initial calibration of the mixed reality system 112. A matrix (which may include a translation matrix and a quaternion matrix, or other rotation matrix), or other suitable representation can characterize a transformation between the user/listener/head coordinate system 114 space and the environment/world coordinate system 108 space. In some embodiments, a left ear coordinate 116 and a right ear coordinate 117 may be defined relative to the origin point 115 of the user/listener/head coordinate system 114. A matrix (which may include a translation matrix and a quaternion matrix, or other rotation matrix), or other suitable representation can characterize a transformation between the left ear coordinate 116 and the right ear coordinate 117, and user/listener/head coordinate system 114 space. The user/listener/head coordinate system 114 can simplify the representation of locations relative to the user's head, or to a head-mounted device, for example, relative to the environment/world coordinate system 108. Using Simultaneous Localization and Mapping (SLAM), visual odometry, or other techniques, a transformation between user coordinate system 114 and environment coordinate system 108 can be determined and updated in real-time.

FIG. 1B illustrates an exemplary virtual environment 130 that corresponds to real environment 100. The virtual environment 130 shown comprises a virtual rectangular room 104B corresponding to real rectangular room 104A; a virtual object 122B corresponding to real object 122A; a virtual object 124B corresponding to real object 124A; and a virtual object 126B corresponding to real object 126A. Metadata associated with the virtual objects 122B, 124B, 126B can include information derived from the corresponding real objects 122A, 124A, 126A. Virtual environment 130 additionally comprises a virtual character 132, which may not correspond to any real object in real environment 100. Real object 128A in real environment 100 may not correspond to any virtual object in virtual environment 130. A persistent coordinate system 133 (comprising an x-axis 133X, a y-axis 133Y, and a z-axis 133Z) with its origin at point 134 (persistent coordinate), can define a coordinate space for virtual content. The origin point 134 of the persistent coordinate system 133 may be defined relative/with respect to one or more real objects, such as the real object 126A. A matrix (which may include a translation matrix and a quaternion matrix, or other rotation matrix), or other suitable representation can characterize a transformation between the persistent coordinate system 133 space and the environment/world coordinate system 108 space. In some embodiments, each of the virtual objects 122B, 124B, 126B, and 132 may have its own persistent coordinate point relative to the origin point 134 of the persistent coordinate system 133. In some embodiments, there may be multiple persistent coordinate systems and each of the virtual objects 122B, 124B, 126B, and 132 may have its own persistent coordinate points relative to one or more persistent coordinate systems.

Persistent coordinate data may be coordinate data that persists relative to a physical environment. Persistent coordinate data may be used by MR systems (e.g., MR system 112, 200) to place persistent virtual content, which may not be tied to movement of a display on which the virtual object is being displayed. For example, a two-dimensional screen may display virtual objects relative to a position on the screen. As the two-dimensional screen moves, the virtual content may move with the screen. In some embodiments, persistent virtual content may be displayed in a corner of a room. A MR user may look at the corner, see the virtual content, look away from the corner (where the virtual content may no longer be visible because the virtual content may have moved from within the user's field of view to a location outside the user's field of view due to motion of the user's head), and look back to see the virtual content in the corner (similar to how a real object may behave).

In some embodiments, persistent coordinate data (e.g., a persistent coordinate system and/or a persistent coordinate frame) can include an origin point and three axes. For example, a persistent coordinate system may be assigned to a center of a room by a MR system. In some embodiments, a user may move around the room, out of the room, re-enter the room, etc., and the persistent coordinate system may remain at the center of the room (e.g., because it persists relative to the physical environment). In some embodiments, a virtual object may be displayed using a transform to persistent coordinate data, which may enable displaying persistent virtual content. In some embodiments, a MR system may use simultaneous localization and mapping to generate persistent coordinate data (e.g., the MR system may assign a persistent coordinate system to a point in space). In some embodiments, a MR system may map an environment by generating persistent coordinate data at regular intervals (e.g., a MR system may assign persistent coordinate systems in a grid where persistent coordinate systems may be at least within five feet of another persistent coordinate system).

In some embodiments, persistent coordinate data may be generated by a MR system and transmitted to a remote server. In some embodiments, a remote server may be configured to receive persistent coordinate data. In some embodiments, a remote server may be configured to synchronize persistent coordinate data from multiple observation instances. For example, multiple MR systems may map the same room with persistent coordinate data and transmit that data to a remote server. In some embodiments, the remote server may use this observation data to generate canonical persistent coordinate data, which may be based on the one or more observations. In some embodiments, canonical persistent coordinate data may be more accurate and/or reliable than a single observation of persistent coordinate data. In some embodiments, canonical persistent coordinate data may be transmitted to one or more MR systems. For example, a MR system may use image recognition and/or location data to recognize that it is located in a room that has corresponding canonical persistent coordinate data (e.g., because other MR systems have previously mapped the room). In some embodiments, the MR system may receive canonical persistent coordinate data corresponding to its location from a remote server.

With respect to FIGS. 1A and 1B, environment/world coordinate system 108 defines a shared coordinate space for both real environment 100 and virtual environment 130. In the example shown, the coordinate space has its origin at point 106. Further, the coordinate space is defined by the same three orthogonal axes (108X, 108Y, 108Z). Accordingly, a first location in real environment 100, and a second, corresponding location in virtual environment 130, can be described with respect to the same coordinate space. This simplifies identifying and displaying corresponding locations in real and virtual environments, because the same coordinates can be used to identify both locations. However, in some examples, corresponding real and virtual environments need not use a shared coordinate space. For instance, in some examples (not shown), a matrix (which may include a translation matrix and a quaternion matrix, or other rotation matrix), or other suitable representation can characterize a transformation between a real environment coordinate space and a virtual environment coordinate space.

FIG. 1C illustrates an exemplary MRE 150 that simultaneously presents aspects of real environment 100 and virtual environment 130 to user 110 via mixed reality system 112. In the example shown, MRE 150 simultaneously presents user 110 with real objects 122A, 124A, 126A, and 128A from real environment 100 (e.g., via a transmissive portion of a display of mixed reality system 112); and virtual objects 122B, 124B, 126B, and 132 from virtual environment 130 (e.g., via an active display portion of the display of mixed reality system 112). As described herein, origin point 106 acts as an origin for a coordinate space corresponding to MRE 150, and coordinate system 108 defines an x-axis, y-axis, and z-axis for the coordinate space.

In the example shown, mixed reality objects comprise corresponding pairs of real objects and virtual objects (e.g., 122A/122B, 124A/124B, 126A/126B) that occupy corresponding locations in coordinate space 108. In some examples, both the real objects and the virtual objects may be simultaneously visible to user 110. This may be desirable in, for example, instances where the virtual object presents information designed to augment a view of the corresponding real object (such as in a museum application where a virtual object presents the missing pieces of an ancient damaged sculpture). In some examples, the virtual objects (122B, 124B, and/or 126B) may be displayed (e.g., via active pixelated occlusion using a pixelated occlusion shutter) so as to occlude the corresponding real objects (122A, 124A, and/or 126A). This may be desirable in, for example, instances where the virtual object acts as a visual replacement for the corresponding real object (such as in an interactive storytelling application where an inanimate real object becomes a “living” character).

In some examples, real objects (e.g., 122A, 124A, 126A) may be associated with virtual content or helper data that may not necessarily constitute virtual objects. Virtual content or helper data can facilitate processing or handling of virtual objects in the mixed reality environment. For example, such virtual content could include two-dimensional representations of corresponding real objects; custom asset types associated with corresponding real objects; or statistical data associated with corresponding real objects. This information can enable or facilitate calculations involving a real object without incurring unnecessary computational overhead.

In some examples, the presentation described herein may also incorporate audio aspects. For instance, in MRE 150, virtual character 132 could be associated with one or more audio signals, such as a footstep sound effect that is generated as the character walks around MRE 150. As described herein, a processor of mixed reality system 112 can compute an audio signal corresponding to a mixed and processed composite of all such sounds in MRE 150, and present the audio signal to user 110 via one or more speakers included in mixed reality system 112 and/or one or more external speakers.

Example mixed reality system 112 can include a wearable head device (e.g., a wearable augmented reality or mixed reality head device) comprising a display (which may comprise left and right transmissive displays, which may be near-eye displays, and associated components for coupling light from the displays to the user's eyes); left and right speakers (e.g., positioned adjacent to the user's left and right ears, respectively); an inertial measurement unit (IMU) (e.g., mounted to a temple arm of the head device); an orthogonal coil electromagnetic receiver (e.g., mounted to the left temple piece); left and right cameras (e.g., depth (time-of-flight) cameras) oriented away from the user; and left and right eye cameras oriented toward the user (e.g., for detecting the user's eye movements). However, a mixed reality system 112 can incorporate any suitable display technology, and any suitable sensors (e.g., optical, infrared, acoustic, LIDAR, EOG, GPS, magnetic). In addition, mixed reality system 112 may incorporate networking features (e.g., Wi-Fi capability, mobile network (e.g., 4G, 5G) capability) to communicate with other devices and systems, including neural networks (e.g., in the cloud) for data processing and training data associated with presentation of elements (e.g., virtual character 132) in the MRE 150 and other mixed reality systems. Mixed reality system 112 may further include a battery (which may be mounted in an auxiliary unit, such as a belt pack designed to be worn around a user's waist), a processor, and a memory. The wearable head device of mixed reality system 112 may include tracking components, such as an IMU or other suitable sensors, configured to output a set of coordinates of the wearable head device relative to the user's environment. In some examples, tracking components may provide input to a processor performing a Simultaneous Localization and Mapping (SLAM) and/or visual odometry algorithm. In some examples, mixed reality system 112 may also include a handheld controller 300, and/or an auxiliary unit 320, which may be a wearable beltpack, as described herein.

In some embodiments, an animation rig is used to present the virtual character 132 in the MRE 150. Although the animation rig is described with respect to virtual character 132, it is understood that the animation rig may be associated with other characters (e.g., a human character, an animal character, an abstract character) in the MRE 150.

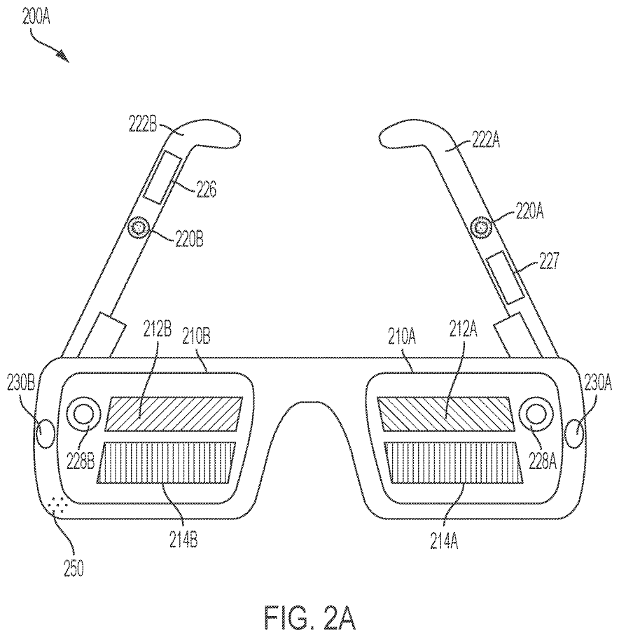

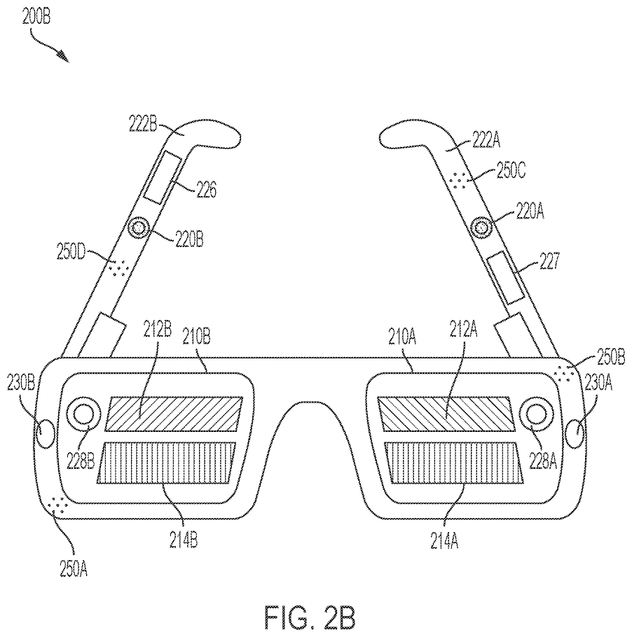

FIG. 2A illustrates an example wearable head device 200A configured to be worn on the head of a user. Wearable head device 200A may be part of a broader wearable system that comprises one or more components, such as a head device (e.g., wearable head device 200A), a handheld controller (e.g., handheld controller 300 described below), and/or an auxiliary unit (e.g., auxiliary unit 400 described below). In some examples, wearable head device 200A can be used for AR, MR, or XR systems or applications. Wearable head device 200A can comprise one or more displays, such as displays 210A and 210B (which may comprise left and right transmissive displays, and associated components for coupling light from the displays to the user's eyes, such as orthogonal pupil expansion (OPE) grating sets 212A/212B and exit pupil expansion (EPE) grating sets 214A/214B); left and right acoustic structures, such as speakers 220A and 220B (which may be mounted on temple arms 222A and 222B, and positioned adjacent to the user's left and right ears, respectively); one or more sensors such as infrared sensors, accelerometers, GPS units, inertial measurement units (IMUs, e.g. IMU 226), acoustic sensors (e.g., microphones 250); orthogonal coil electromagnetic receivers (e.g., receiver 227 shown mounted to the left temple arm 222A); left and right cameras (e.g., depth (time-of-flight) cameras 230A and 230B) oriented away from the user; and left and right eye cameras oriented toward the user (e.g., for detecting the user's eye movements) (e.g., eye cameras 228A and 228B). However, wearable head device 200A can incorporate any suitable display technology, and any suitable number, type, or combination of sensors or other components without departing from the scope of the invention. In some examples, wearable head device 200A may incorporate one or more microphones 250 configured to detect audio signals generated by the user's voice; such microphones may be positioned adjacent to the user's mouth and/or on one or both sides of the user's head. In some examples, wearable head device 200A may incorporate networking features (e.g., Wi-Fi capability) to communicate with other devices and systems, including other wearable systems. Wearable head device 200A may further include components such as a battery, a processor, a memory, a storage unit, or various input devices (e.g., buttons, touchpads); or may be coupled to a handheld controller (e.g., handheld controller 300) or an auxiliary unit (e.g., auxiliary unit 400) that comprises one or more such components. In some examples, sensors may be configured to output a set of coordinates of the head-mounted unit relative to the user's environment, and may provide input to a processor performing a Simultaneous Localization and Mapping (SLAM) procedure and/or a visual odometry algorithm. In some examples, wearable head device 200A may be coupled to a handheld controller 300, and/or an auxiliary unit 400, as described further below.

FIG. 2B illustrates an example wearable head device 200B (that can correspond to wearable head device 200A) configured to be worn on the head of a user. In some embodiments, wearable head device 200B can include a multi-microphone configuration, including microphones 250A, 250B, 250C, and 250D. Multi-microphone configurations can provide spatial information about a sound source in addition to audio information. For example, signal processing techniques can be used to determine a relative position of an audio source to wearable head device 200B based on the amplitudes of the signals received at the multi-microphone configuration. If the same audio signal is received with a larger amplitude at microphone 250A than at 250B, it can be determined that the audio source is closer to microphone 250A than to microphone 250B. Asymmetric or symmetric microphone configurations can be used. In some embodiments, it can be advantageous to asymmetrically configure microphones 250A and 250B on a front face of wearable head device 200B. For example, an asymmetric configuration of microphones 250A and 250B can provide spatial information pertaining to height (e.g., a distance from a first microphone to a voice source (e.g., the user's mouth, the user's throat) and a second distance from a second microphone to the voice source are different). This can be used to distinguish a user's speech from other human speech. For example, a ratio of amplitudes received at microphone 250A and at microphone 250B can be expected for a user's mouth to determine that an audio source is from the user. In some embodiments, a symmetrical configuration may be able to distinguish a user's speech from other human speech to the left or right of a user. Although four microphones are shown in FIG. 2B, it is contemplated that any suitable number of microphones can be used, and the microphone(s) can be arranged in any suitable (e.g., symmetrical or asymmetrical) configuration.

In some embodiments, the disclosed asymmetrical microphone arrangements allow the system to record a sound field more independently from a user's movements (e.g., head rotation) (e.g., by allowing head movement along all axes of the environment to be detected acoustically, by allowing a sound field that may be more easily adjusted (e.g., the sound field has more information along different axes of the environment) to compensate these movements). More examples of these features and advantages are described herein.

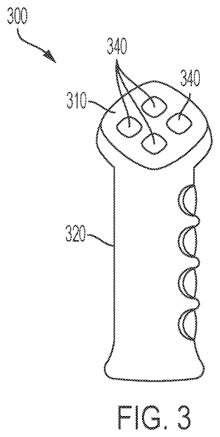

FIG. 3 illustrates an example mobile handheld controller component 300 of an example wearable system. In some examples, handheld controller 300 may be in wired or wireless communication with wearable head device 200A and/or 200B and/or auxiliary unit 400 described below. In some examples, handheld controller 300 includes a handle portion 320 to be held by a user, and one or more buttons 340 disposed along a top surface 310. In some examples, handheld controller 300 may be configured for use as an optical tracking target; for example, a sensor (e.g., a camera or other optical sensor) of wearable head device 200A and/or 200B can be configured to detect a position and/or orientation of handheld controller 300—which may, by extension, indicate a position and/or orientation of the hand of a user holding handheld controller 300. In some examples, handheld controller 300 may include a processor, a memory, a storage unit, a display, or one or more input devices, such as ones described herein. In some examples, handheld controller 300 includes one or more sensors (e.g., any of the sensors or tracking components described herein with respect to wearable head device 200A and/or 200B). In some examples, sensors can detect a position or orientation of handheld controller 300 relative to wearable head device 200A and/or 200B or to another component of a wearable system. In some examples, sensors may be positioned in handle portion 320 of handheld controller 300, and/or may be mechanically coupled to the handheld controller. Handheld controller 300 can be configured to provide one or more output signals, corresponding, for example, to a pressed state of the buttons 340; or a position, orientation, and/or motion of the handheld controller 300 (e.g., via an IMU). Such output signals may be used as input to a processor of wearable head device 200A and/or 200B, to auxiliary unit 400, or to another component of a wearable system. In some examples, handheld controller 300 can include one or more microphones to detect sounds (e.g., a user's speech, environmental sounds), and in some cases provide a signal corresponding to the detected sound to a processor (e.g., a processor of wearable head device 200A and/or 200B).

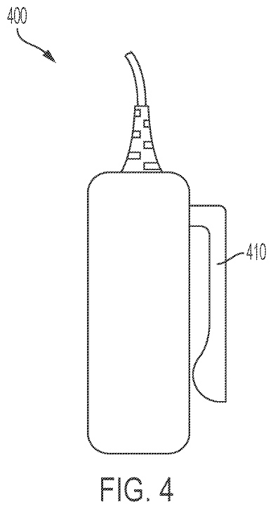

FIG. 4 illustrates an example auxiliary unit 400 of an example wearable system. In some examples, auxiliary unit 400 may be in wired or wireless communication with wearable head device 200A and/or 200B and/or handheld controller 300. The auxiliary unit 400 can include a battery to primarily or supplementally provide energy to operate one or more components of a wearable system, such as wearable head device 200A and/or 200B and/or handheld controller 300 (including displays, sensors, acoustic structures, processors, microphones, and/or other components of wearable head device 200A and/or 200B or handheld controller 300). In some examples, auxiliary unit 400 may include a processor, a memory, a storage unit, a display, one or more input devices, and/or one or more sensors, such as ones described herein. In some examples, auxiliary unit 400 includes a clip 410 for attaching the auxiliary unit to a user (e.g., attaching the auxiliary unit to a belt worn by the user). An advantage of using auxiliary unit 400 to house one or more components of a wearable system is that doing so may allow larger or heavier components to be carried on a user's waist, chest, or back—which are relatively well suited to support larger and heavier objects—rather than mounted to the user's head (e.g., if housed in wearable head device 200A and/or 200B) or carried by the user's hand (e.g., if housed in handheld controller 300). This may be particularly advantageous for relatively heavier or bulkier components, such as batteries.

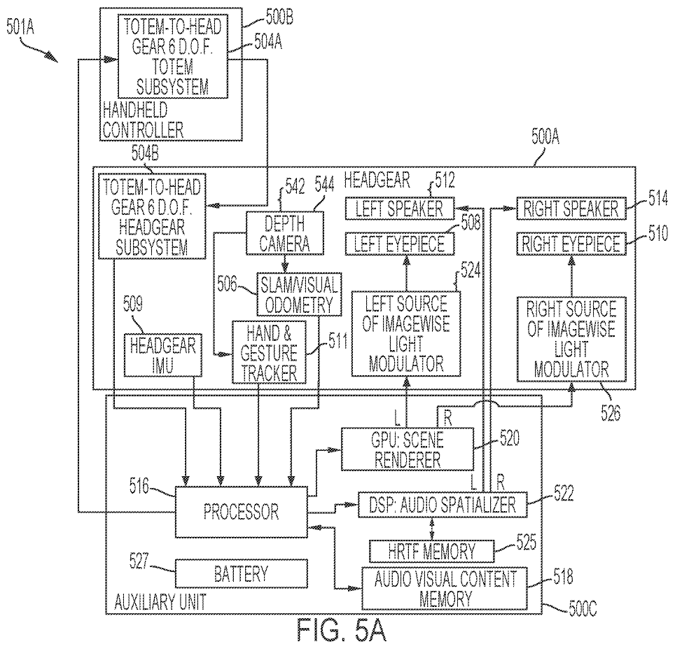

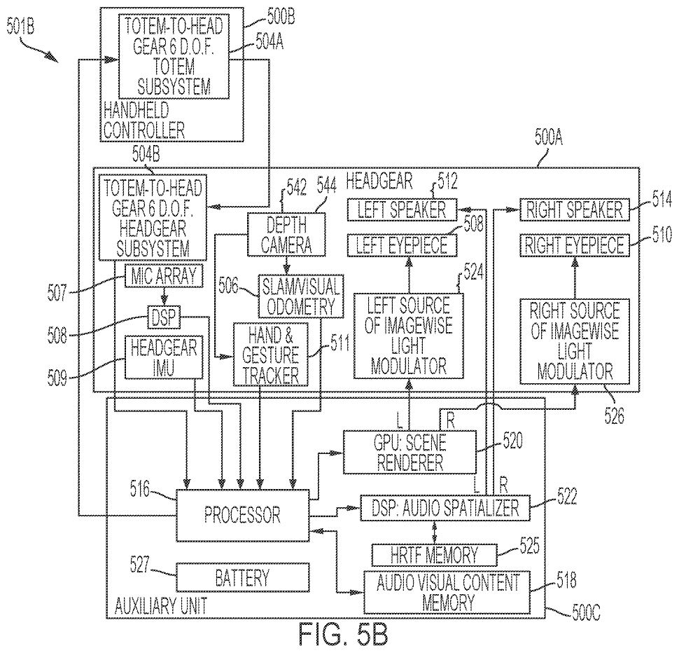

FIG. 5A shows an example functional block diagram that may correspond to an example wearable system 501A; such system may include example wearable head device 200A and/or 200B, handheld controller 300, and auxiliary unit 400 described herein. In some examples, the wearable system 501A could be used for AR, MR, or XR applications. As shown in FIG. 5, wearable system 501A can include example handheld controller 500B, referred to here as a “totem” (and which may correspond to handheld controller 300); the handheld controller 500B can include a totem-to-headgear six degree of freedom (6DOF) totem subsystem 504A. Wearable system 501A can also include example headgear device 500A (which may correspond to wearable head device 200A and/or 200B); the headgear device 500A includes a totem-to-headgear 6DOF headgear subsystem 504B. In the example, the 6DOF totem subsystem 504A and the 6DOF headgear subsystem 504B cooperate to determine six coordinates (e.g., offsets in three translation directions and rotation along three axes) of the handheld controller 500B relative to the headgear device 500A. The six degrees of freedom may be expressed relative to a coordinate system of the headgear device 500A. The three translation offsets may be expressed as X, Y, and Z offsets in such a coordinate system, as a translation matrix, or as some other representation. The rotation degrees of freedom may be expressed as sequence of yaw, pitch and roll rotations; as vectors; as a rotation matrix; as a quaternion; or as some other representation. In some examples, one or more depth cameras 544 (and/or one or more non-depth cameras) included in the headgear device 500A; and/or one or more optical targets (e.g., buttons 340 of handheld controller 300 as described, dedicated optical targets included in the handheld controller) can be used for 6DOF tracking. In some examples, the handheld controller 500B can include a camera, as described; and the headgear device 500A can include an optical target for optical tracking in conjunction with the camera. In some examples, the headgear device 500A and the handheld controller 500B each include a set of three orthogonally oriented solenoids which are used to wirelessly send and receive three distinguishable signals. By measuring the relative magnitude of the three distinguishable signals received in each of the coils used for receiving, the 6DOF of the handheld controller 500B relative to the headgear device 500A may be determined. In some examples, 6DOF totem subsystem 504A can include an Inertial Measurement Unit (IMU) that is useful to provide improved accuracy and/or more timely information on rapid movements of the handheld controller 500B.

FIG. 5B shows an example functional block diagram that may correspond to an example wearable system 501B (which can correspond to example wearable system 501A). In some embodiments, wearable system 501B can include microphone array 507, which can include one or more microphones arranged on headgear device 500A. In some embodiments, microphone array 507 can include four microphones. Two microphones can be placed on a front face of headgear 500A, and two microphones can be placed at a rear of head headgear 500A (e.g., one at a back-left and one at a back-right), such as the configuration described with respect to FIG. 2B. The microphone array 507 can include any suitable number of microphones, and can include a single microphone. In some embodiments, signals received by microphone array 507 can be transmitted to DSP 508. DSP 508 can be configured to perform signal processing on the signals received from microphone array 507. For example, DSP 508 can be configured to perform noise reduction, acoustic echo cancellation, and/or beamforming on signals received from microphone array 507. DSP 508 can be configured to transmit signals to processor 516. In some embodiments, the system 501B can include multiple signal processing stages that may each be associated with one or more microphones. In some embodiments, the multiple signal processing stages are each associated with a microphone of a combination of two or more microphones used for beamforming. In some embodiments, the multiple signal processing stages are each associated with noise reduction or echo-cancellation algorithms used to pre-process a signal used for either voice onset detection, key phrase detection, or endpoint detection.

In some examples involving augmented reality or mixed reality applications, it may be desirable to transform coordinates from a local coordinate space (e.g., a coordinate space fixed relative to headgear device 500A) to an inertial coordinate space, or to an environmental coordinate space. For instance, such transformations may be necessary for a display of headgear device 500A to present a virtual object at an expected position and orientation relative to the real environment (e.g., a virtual person sitting in a real chair, facing forward, regardless of the position and orientation of headgear device 500A), rather than at a fixed position and orientation on the display (e.g., at the same position in the display of headgear device 500A). This can maintain an illusion that the virtual object exists in the real environment (and does not, for example, appear positioned unnaturally in the real environment as the headgear device 500A shifts and rotates). In some examples, a compensatory transformation between coordinate spaces can be determined by processing imagery from the depth cameras 544 (e.g., using a Simultaneous Localization and Mapping (SLAM) and/or visual odometry procedure) in order to determine the transformation of the headgear device 500A relative to an inertial or environmental coordinate system. In the example shown in FIG. 5, the depth cameras 544 can be coupled to a SLAM/visual odometry block 506 and can provide imagery to block 506. The SLAM/visual odometry block 506 implementation can include a processor configured to process this imagery and determine a position and orientation of the user's head, which can then be used to identify a transformation between a head coordinate space and a real coordinate space. Similarly, in some examples, an additional source of information on the user's head pose and location is obtained from an IMU 509 of headgear device 500A. Information from the IMU 509 can be integrated with information from the SLAM/visual odometry block 506 to provide improved accuracy and/or more timely information on rapid adjustments of the user's head pose and position.

In some examples, the depth cameras 544 can supply 3D imagery to a hand gesture tracker 511, which may be implemented in a processor of headgear device 500A. The hand gesture tracker 511 can identify a user's hand gestures, for example by matching 3D imagery received from the depth cameras 544 to stored patterns representing hand gestures. Other suitable techniques of identifying a user's hand gestures will be apparent.

In some examples, one or more processors 516 may be configured to receive data from headgear subsystem 504B, the IMU 509, the SLAM/visual odometry block 506, depth cameras 544, microphones 550; and/or the hand gesture tracker 511. The processor 516 can also send and receive control signals from the 6DOF totem system 504A. The processor 516 may be coupled to the 6DOF totem system 504A wirelessly, such as in examples where the handheld controller 500B is untethered. Processor 516 may further communicate with additional components, such as an audio-visual content memory 518, a Graphical Processing Unit (GPU) 520, and/or a Digital Signal Processor (DSP) audio spatializer 522. The DSP audio spatializer 522 may be coupled to a Head Related Transfer Function (HRTF) memory 525. The GPU 520 can include a left channel output coupled to the left source of imagewise modulated light 524 and a right channel output coupled to the right source of imagewise modulated light 526. GPU 520 can output stereoscopic image data to the sources of imagewise modulated light 524, 526. The DSP audio spatializer 522 can output audio to a left speaker 512 and/or a right speaker 514. The DSP audio spatializer 522 can receive input from processor 519 indicating a direction vector from a user to a virtual sound source (which may be moved by the user, e.g., via the handheld controller 500B). Based on the direction vector, the DSP audio spatializer 522 can determine a corresponding HRTF (e.g., by accessing a HRTF, or by interpolating multiple HRTFs). The DSP audio spatializer 522 can then apply the determined HRTF to an audio signal, such as an audio signal corresponding to a virtual sound generated by a virtual object. This can enhance the believability and realism of the virtual sound, by incorporating the relative position and orientation of the user relative to the virtual sound in the mixed reality environment—that is, by presenting a virtual sound that matches a user's expectations of what that virtual sound would sound like if it were a real sound in a real environment.

In some examples, such as shown in FIG. 5, one or more of processor 516, GPU 520, DSP audio spatializer 522, HRTF memory 525, and audio/visual content memory 518 may be included in an auxiliary unit 500C (which may correspond to auxiliary unit 400). The auxiliary unit 500C may include a battery 527 to power its components and/or to supply power to headgear device 500A and/or handheld controller 500B. Including such components in an auxiliary unit, which can be mounted to a user's waist, can limit or reduce the size and weight of headgear device 500A, which can in turn reduce fatigue of a user's head and neck. In some embodiments, the auxiliary unit is a cell phone, tablet, or a second computing device.

While FIGS. 5A and 5B present elements corresponding to various components of an example wearable systems 501A and 501B, various other suitable arrangements of these components will become apparent to those skilled in the art. For example, the headgear device 500A illustrated in FIG. 5A or FIG. 5B may include a processor and/or a battery (not shown). The included processor and/or battery may operate together with or operate in place of the processor and/or battery of the auxiliary unit 500C. Generally, as another example, elements presented or functionalities described with respect to FIG. 5 as being associated with auxiliary unit 500C could instead be associated with headgear device 500A or handheld controller 500B. Furthermore, some wearable systems may forgo entirely a handheld controller 500B or auxiliary unit 500C. Such changes and modifications are to be understood as being included within the scope of the disclosed examples.

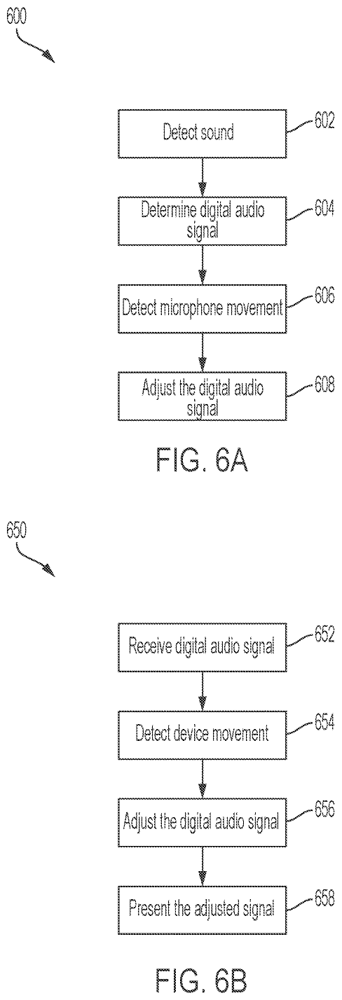

FIG. 6A illustrates an exemplary method 600 of capturing a sound field according to some embodiments of the disclosure. Although the method 600 is illustrated as including the described steps, it is understood that a different order of steps, additional steps, or fewer steps may be included without departing from the scope of the disclosure. For example, steps of method 600 may be performed with steps of other disclosed methods.

In some embodiments, computation, determination, calculation, or derivation steps of method 600 are performed using a processor (e.g., processor of MR system 112, processor of wearable head device 200A, processor of wearable head device 200B, processor of handheld controller 300, processor of auxiliary unit 400, processor 516, DSP 522) of a wearable head device or an AR/MR/XR system and/or using a server (e.g., in the cloud).

In some embodiments, the method 600 includes detecting a sound (step 602). For example, a sound is detected by a microphone (e.g., microphone 250; microphones 250A, 250B, 250C, and 250D; microphone of handheld controller 300; microphone array 507) of a wearable head device or an AR/MR/XR system. In some embodiments, the sound includes a sound from a sound field or a 3-D audio scene of an environment (an AR, MR, or XR environment) of the wearable head device or the AR/MR/XR system.

In some examples, while the sound is being detected by the microphone, the microphone may not be stationary. For example, a user of the device including the microphone may not be stationary, such that the sound does not appear to be recorded at a fixed location and position. In some instances, the user wears a wearable head device including the microphone, and the user's head is not stationary (e.g., the user's headpose or head orientation changes over time) due to intentional and/or unintentional head movements. By processing the detected sound as described herein, a recording corresponding to the detected sound may be compensated for these movements, as if the sound was detected by a stationary microphone.

In some embodiments, the method 600 includes determining a digital audio signal based on the detected sound (step 604). In some embodiments, the digital audio signal is associated with a sphere having a position (e.g., a location, an orientation) in an environment (e.g., an AR, MR, or XR environment). As used herein, it is understood that “sphere” and “spherical” are not meant to limit an audio signal, a signal representation, or a sound to a strictly spherical pattern or geometry. As used herein, a “sphere” or “spherical” may refer to a pattern or geometry comprising components that span more than three dimensions of an environment.

For example, a spherical signal representation of the detected sound is derived. In some embodiments, the spherical signal representation represents a sound field with respect to a point in space (e.g., the sound field at a location of the recording device). For example, a 3-D spherical signal representation is derived based on the sound detected by the microphone in step 602. In some embodiments, in response to receiving signals corresponding to the detected sound, the 3-D spherical signal representation is determined using a processor (e.g., processor of MR system 112, processor of wearable head device 200A, processor of wearable head device 200B, processor of handheld controller 300, processor of auxiliary unit 400, processor 516, DSP 522) of a wearable head device or an AR/MR/XR system.

In some embodiments, the digital audio signal (e.g., a spherical signal representation) is in an Ambisonics or spherical harmonics format. The Ambisonics format advantageously allow the spherical signal representation to be efficiently edited for headpose compensation (e.g., an orientation associated of the Ambisonics representation may be easily translated to compensate for movement during sound detection).

In some embodiments, the method 600 includes detecting a microphone movement (step 606). In some embodiments, the method 600 includes concurrently with detecting the sound (e.g., from step 602), detecting, via a sensor of a wearable head device, a microphone movement with respect to the environment.

In some embodiments, a movement (e.g., changing headpose) of a recording device (e.g., MR system 112, wearable head device 200A, wearable head device 200B, handheld controller 300, wearable system 501A, wearable system 501B) is determined during sound detection (e.g., from step 602). For example, the movement is determined by a sensor (e.g., IMU (e.g., IMU 509), camera (e.g., cameras 228A, 228B; camera 544), a second microphone, gyroscope, LiDAR sensor, or other suitable sensor) of the device and/or by using AR/MR/XR localization techniques, such as simultaneous localization and mapping (SLAM) and/or visual inertial odometry (VIO). Determined movement may be, for example, three degree-of-freedom (3DOF) movement or six degree-of-freedom (6DOF) movement.

In some embodiments, the method 600 includes adjusting the digital audio signal (step 608). In some embodiments, the adjusting comprises adjusting the position (e.g., a location, an orientation) of the sphere based on based on the detected microphone movement (e.g., magnitude, direction). For example, after the 3-D spherical signal representation is derived (e.g., from step 604), a user's headpose is compensated with the adjustment. In some embodiments, a function for headpose compensation is derived based on the detected movement. For example, the function can represent a translation and/or rotation that corresponds to an opposite of the detected movement. As an example, at a time of sound detection, a headpose rotation of 2 degrees about a Z-axis is determined (e.g., by a method described herein). To compensate for this movement, the function for headpose compensation includes a −2 degrees translation about the Z-axis to counteract the effects of the movement on a sound recording at this time of sound detection. In some embodiments, the function for headpose compensation is determined by applying an inverse transformation on a representation of the detected movement during sound detection.

In some embodiments, the movement is represented by a matrix or vectors in space, which may be used to determine an amount of compensation needed to generate a fixed-orientation recording. For example, the function can include vectors (as a function of sound detection time) in an opposite direction of the movement vectors to represent a translation for counteracting the effects of movement on a recording during sound detection.

In some embodiments, the method 600 includes generating a fixed-orientation recording. The fixed-orientation recording may be an adjusted digital audio signal (e.g., a compensated digital audio signal configured to be presented to a listener). For example, based on headpose compensation (e.g., from step 608), a fixed-orientation recording is generated. In some embodiments, the fixed-orientation recording is unaffected by a user's head orientation and/or movement during recording (e.g., from step 602). In some embodiments, the fixed-orientation recording includes location and/or position information of the recording device in the AR/MR/XR environment, and the location and/or position information indicate a location and orientation of the recorded sound content in the AR/MR/XR environment.

In some embodiments, the digital audio signal (e.g., a spherical signal representation) is in an Ambisonics format, and the Ambisonics format advantageously allows a system to efficiently update coordinates of the spherical signal representation for headpose compensation (e.g., an orientation associated of the Ambisonics representation may be easily translated to compensate for movement during sound detection). After the movement of the recording device is determined (e.g., using a method described herein), a function for headpose compensation is derived, as described herein. Based on the derived function, Ambisonics signal representation may be updated to compensate for the device movement to generate a fixed-orientation recording (e.g., an adjusted digital audio signal).

As an example, at a time of sound detection, a headpose rotation of 2 degrees about a Z-axis is determined (e.g., by a method described herein). To compensate for this movement, the function for headpose compensation includes a −2 degrees translation about the Z-axis to counteract the effects of the movement on a sound recording at this time of sound detection. The function is applied to the Ambisonics spherical signal representation at a corresponding time (e.g., the time of this movement during sound capture) to translate the signal representation by −2 degree translation about the Z-axis, and a fixed-orientation recording of this time is generated. After the application of the function to the spherical signal representation, a fixed-orientation recording unaffected by a user's head orientation and/or movement during recording is generated (e.g., the effects of the 2-degree movement during sound detection are unnoticed by a user listening to the fixed-orientation recording).

In some instances, a user of the device including the microphone may not be stationary, such that the sound does not appear to be recorded at a fixed location and position. For example, the user wears a wearable head device including the microphone, and the user's head is not stationary (e.g., the user's headpose or head orientation changes over time) due to intentional and/or unintentional head movements. By compensating for the headpose and generating a fixed-orientation recording, as described herein, a recording corresponding to the detected sound may be compensated for these movements, as if the sound was detected by a stationary microphone.

In some embodiments, the method 600 advantageously enables producing of a recording of a 3-D audio scene surrounding a user (e.g., of a wearable head device), and the recording is unaffected by the user's head orientation. A recording unaffected by the user's head orientation allows a more accurate audio reproduction of an AR/MR/XR environment, as described in more detail herein.

FIG. 6B illustrates an exemplary method 650 of playing an audio from a sound field according to some embodiments of the disclosure. Although the method 650 is illustrated as including the described steps, it is understood that a different order of steps, additional steps, or fewer steps may be included without departing from the scope of the disclosure. For example, steps of method 650 may be performed with steps of other disclosed methods.

In some embodiments, computation, determination, calculation, or derivation steps of method 650 are performed using a processor (e.g., processor of MR system 112, processor of wearable head device 200A, processor of wearable head device 200B, processor of handheld controller 300, processor of auxiliary unit 400, processor 516, DSP 522) of a wearable head device or an AR/MR/XR system and/or using a server (e.g., in the cloud).

In some embodiments, the method 650 includes receiving a digital audio signal (step 652). In some embodiments, the method 650 includes receiving, at a wearable head device, a digital audio signal. The digital audio signal is associated with a sphere having a position (e.g., a location, an orientation) in the environment (e.g., an AR, MR, or XR environment). For example, a fixed-orientation recording (e.g., an adjusted digital audio signal) is retrieved by an AR/MR/XR device (e.g., MR system 112, wearable head device 200A, wearable head device 200B, handheld controller 300, wearable system 501A, wearable system 501B). In some embodiments, the recording includes sounds from a sound field or a 3-D audio scene of an AR/MR/XR environment of the wearable head device or an AR/MR/XR system detected and processed using the methods described herein. In some embodiment, the recording is a fixed-orientation recording (as described herein). The fixed-orientation recording can be presented to a listener as if the sound of the recording was detected by a stationary microphone. In some embodiments, the fixed-orientation recording includes location and/or position information of the recording device in the AR/MR/XR environment, and the location and/or position information indicate a location and orientation of the recorded sound content in the AR/MR/XR environment.

In some embodiments, the recording includes sounds from a sound field or a 3-D audio scene of an AR/MR/XR environment (e.g., audio of AR/MR/XR content). In some embodiments, the recording includes sounds from a fixed sound source of an AR/MR/XR environment (e.g., from a fixed object of the AR/MR/XR environment).

In some embodiments, the recording includes a spherical signal representation (e.g., in Ambisonics format). In some embodiments, the recording is converted into a spherical signal representation (e.g., in Ambisonics format). The spherical signal representation may be advantageously updated to compensate for a user's headpose during audio playback of the recording.

In some embodiments, the method 650 includes detecting a device movement (step 654). In some embodiments, the method 650 includes detecting, via a sensor of the wearable head device, a device movement with respect to the environment. For example, in some embodiments, a movement (e.g., changing headpose) of a recording device (e.g., MR system 112, wearable head device 200A, wearable head device 200B, handheld controller 300, wearable system 501A, wearable system 501B) is determined while the user is listening to the audio. For example, the movement is determined by a sensor (e.g., IMU (e.g., IMU 509), camera (e.g., cameras 228A, 228B; camera 544), a second microphone, gyroscope, LiDAR sensor, or other suitable sensor) of the device and/or by using AR/MR/XR localization techniques, such as simultaneous localization and mapping (SLAM) and/or visual inertial odometry (VIO). Determined movement may be, for example, three degree-of-freedom (3DOF) movement or six degree-of-freedom (6DOF) movement.

In some embodiments, the method 650 includes adjusting the digital audio signal (step 656). In some embodiments, the adjusting comprises adjusting the position of the sphere based on based on the detected device movement (e.g., magnitude, direction).

In some embodiments, a function for headpose compensation is derived based on the detected movement. For example, the function can represent a translation and/or rotation that corresponds to an opposite of the detected movement. As an example, at a time of sound detection, a headpose rotation of 2 degrees about a Z-axis is determined (e.g., by a method described herein). To compensate for this movement, the function for headpose compensation includes a −2 degrees translation about the Z-axis to counteract the effects of the movement on a sound recording at this time of sound detection. In some embodiments, the function for headpose compensation is determined by applying an inverse transformation on a representation of the detected movement during sound detection.

In some embodiments, the movement is represented by a matrix or vectors in space, which may be used to determine an amount of compensation needed to generate a fixed-orientation recording. For example, the function can include vectors (as a function of sound detection time) in an opposite direction of the movement vectors to represent a translation for counteracting the effects of movement on a recording during sound detection.

In some embodiments, the function for headpose compensation is applied to the recording or a spherical signal representation of the recording (e.g., a digital audio signal) to compensate for the headpose. In some embodiments, the spherical signal representation is in an Ambisonics format, and the Ambisonics format advantageously allows a system to efficiently update coordinates of the spherical signal representation for headpose compensation (e.g., an orientation associated of the Ambisonics representation may be easily translated to compensate for movement during playback). After the movement of the playback device is determined (e.g., using a method described herein), a function for headpose compensation is derived, as described herein. Based on the derived function, Ambisonics signal representation may be updated to compensate for the device movement.

As an example, during playback, a headpose rotation of 2 degrees about a Z-axis is determined (e.g., by a method described herein). To compensate for this movement, the function for headpose compensation includes a −2 degrees translation about the Z-axis to counteract the effects of the movement at this time of playback. The function is applied to the Ambisonics spherical signal representation at a corresponding time (e.g., the time of this movement during playback) to translate the signal representation by −2 degree translation about the Z-axis. After the application of the function to the spherical signal representation, a second spherical signal representation may be generated (e.g., the effects of the 2-degree movement during playback do not affect a fixed sound source location).

In some embodiments, the method 650 includes presenting the adjusted digital audio signal (step 658). In some embodiments, the method 650 includes presenting the adjusted digital audio signal to a user of the wearable head device via one or more speakers of the wearable head device. For example, after a user's headpose is compensated (e.g., using step 654), the compensated spherical signal representation converts to a binaural signal (e.g., an adjusted digital audio signal). In some embodiments, the binaural signal corresponds to an audio output to the user, and the audio output compensates for the user's movements, using the methods described herein. It is understood that binaural signal is merely an example of this conversion. In some embodiments, more generally, the compensated spherical signal representation converts into an audio signal that corresponds to an audio output being outputted by one or more speakers. In some embodiment, the conversion is performed by a processor (e.g., processor of MR system 112, processor of wearable head device 200A, processor of wearable head device 200B, processor of handheld controller 300, processor of auxiliary unit 400, processor 516, DSP 522) of a wearable head device or an AR/MR/XR system.

The wearable head device or AR/MR/XR system may play the audio output corresponding to the converted binaural signal or audio signal (e.g., an adjusted digital audio signal). In some embodiments, the audio is compensated for movement of the device. That is, the audio playback would appear to originate from a fixed sound source of an AR/MR/XR environment. For example, a user in an AR/MR/XR environment rotates his or her head to the right away from a fixed sound source (e.g., a virtual speaker). After the head rotation, the user's left ear is closer to the fixed sound source. After performing the disclosed compensation, the audio from the fixed sound source to the user's left ear would be louder.

In some embodiments, the method 650 advantageously allows a 3-D sound field representation to be rotated based on a listener's head movement at playback time, before being decoded into a binaural representation for playback. The audio playback would appear to originate from a fixed sound source of an AR/MR/XR environment, providing the user a more realistic AR/MR/XR experience (e.g., a fixed AR/MR/XR object would appear fixed aurally while a user moves relative to the corresponding fixed object (e.g., changes headpose)).

In some embodiments, the method 600 may be performed using more than one device or system. That is, more than one device or system may capture a sound field or audio scene, and the effects of movements of the devices or systems on the sound field or audio scene captures may be compensated.

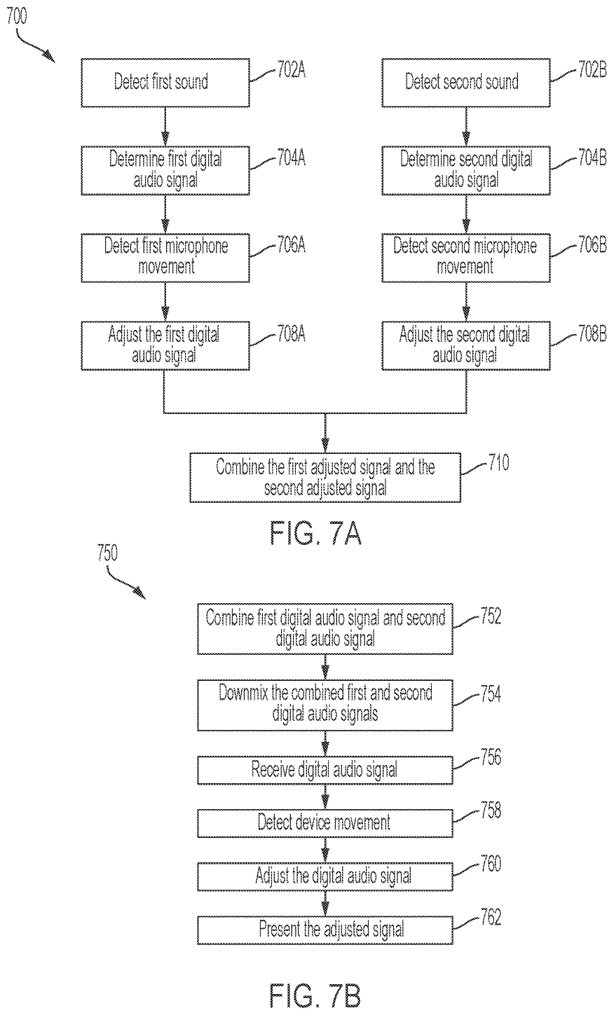

FIG. 7A illustrates an exemplary method 700 of capturing a sound field according to some embodiments of the disclosure. Although the method 700 is illustrated as including the described steps, it is understood that a different order of steps, additional steps, or fewer steps may be included without departing from the scope of the disclosure. For example, steps of method 700 may be performed with steps of other disclosed methods.

In some embodiments, computation, determination, calculation, or derivation steps of method 700 are performed using a processor (e.g., processor of MR system 112, processor of wearable head device 200A, processor of wearable head device 200B, processor of handheld controller 300, processor of auxiliary unit 400, processor 516, DSP 522) of a wearable head device or an AR/MR/XR system and/or using a server (e.g., in the cloud).

In some embodiments, the method 700 includes detecting a first sound (step 702A). For example, a sound is detected by a microphone (e.g., microphone 250; microphones 250A, 250B, 250C, and 250D; microphone of handheld controller 300; microphone array 507) of a first wearable head device or a first AR/MR/XR system. In some embodiments, the sound includes a sound from a sound field or a 3-D audio scene of an AR/MR/XR environment of the first wearable head device or the first AR/MR/XR system.

In some embodiments, the method 700 includes determining a first digital audio signal based on the first detected sound (step 704A). In some embodiments, the first digital audio signal is associated with a first sphere having a first position (e.g., a location, an orientation) in an environment (e.g., an AR, MR, or XR environment).

For example, a first spherical signal representation of the first detected sound is derived. In some embodiments, the spherical signal representation represents a sound field with respect to a point in space (e.g., the sound field at a location of the first recording device). For example, a 3-D spherical signal representation is derived based on the sound detected by the microphone in step 702A. In some embodiments, in response to receiving signals corresponding to the detected sound, the 3-D spherical signal representation is determined using a processor (e.g., processor of MR system 112, processor of wearable head device 200A, processor of wearable head device 200B, processor of handheld controller 300, processor of auxiliary unit 400, processor 516, DSP 522) of a first wearable head device or a first AR/MR/XR system. In some embodiments, the spherical signal representation is in an Ambisonics or spherical harmonics format.

In some embodiments, the method 700 includes detecting a first microphone movement (step 706A). In some embodiments, the method 700 includes concurrently with detecting the first sound, detecting, via a sensor of the first wearable head device, a first microphone movement with respect to the environment. In some embodiments, the movement (e.g., changing headpose) of the first recording device (e.g., MR system 112, wearable head device 200A, wearable head device 200B, handheld controller 300, wearable system 501A, wearable system 501B) is determined during sound detection (e.g., from step 702A). For example, the movement is determined by a sensor (e.g., IMU (e.g., IMU 509), camera (e.g., cameras 228A, 228B; camera 544), a second microphone, gyroscope, LiDAR sensor, or other suitable sensor) of the first device and/or by using AR/MR/XR localization techniques, such as simultaneous localization and mapping (SLAM) and/or visual inertial odometry (VIO). Determined movement may be, for example, three degree-of-freedom (3DOF) movement or six degree-of-freedom (6DOF) movement.

In some embodiments, the method 700 includes adjusting the first digital audio signal (step 708A). In some embodiments, the adjusting comprises adjusting the first position (e.g., a location, an orientation) of the first sphere based on based on the detected first microphone movement (e.g., magnitude, direction). For example, after the first 3-D spherical signal representation is derived (e.g., from step 704A), a first user's headpose is compensated with the adjustment. In some embodiments, a first function for first headpose compensation is derived based on the detected movement. For example, the first function can represent a translation and/or rotation that corresponds to an opposite of the detected movement. As an example, at a time of sound detection, a first headpose rotation of 2 degrees about a Z-axis is determined (e.g., by a method described herein). To compensate for this movement, the first function for first headpose compensation includes a −2 degrees translation about the Z-axis to counteract the effects of the movement on a sound recording at this time of sound detection. In some embodiments, the first function for first headpose compensation is determined by applying an inverse transformation on a representation of the detected movement during sound detection.

In some embodiments, the movement is represented by a matrix or vectors in space, which may be used to determine an amount of compensation needed to generate a fixed-orientation recording. For example, the first function can include vectors (as a function of sound detection time) in an opposite direction of the movement vectors to represent a translation for counteracting the effects of movement on a first recording during sound detection.

In some embodiments, the method 700 includes generating a first fixed-orientation recording. The first fixed-orientation recording may be an adjusted first digital audio signal (e.g., a compensated digital audio signal configured to be presented to a listener). For example, based on first headpose compensation (e.g., from step 708A), a first fixed-orientation recording is generated. In some embodiments, the first fixed-orientation recording is unaffected by a first user's head orientation and/or movement during recording (e.g., from step 702A). In some embodiments, the first fixed-orientation recording includes location and/or position information of the first recording device in the AR/MR/XR environment, and the location and/or position information indicate a location and orientation of the first recorded sound content in the AR/MR/XR environment.

In some embodiments, the first digital audio signal (e.g., a spherical signal representation) is in an Ambisonics format. After the movement of the first recording device is determined (e.g., using a method described herein), a first function for headpose compensation is derived, as described herein. Based on the derived first function, the Ambisonics signal representation may be updated to compensate for the first device movement to generate a first fixed-orientation recording.

As an example, at a time of sound detection, a first headpose rotation of 2 degrees about a Z-axis is determined (e.g., by a method described herein). To compensate for this movement, the first function for first headpose compensation includes a −2 degrees translation about the Z-axis to counteract the effects of the movement on a sound recording at this time of sound detection. The first function is applied to the Ambisonics spherical signal representation at a corresponding time (e.g., the time of this movement during sound capture) to translate the signal representation by −2 degree translation about the Z-axis, and a first fixed-orientation recording of this time is generated. After the application of the first function to the first spherical signal representation, a first fixed-orientation recording unaffected by a first user's head orientation and/or movement during recording is generated (e.g., the effects of the 2-degree movement during sound detection are unnoticed by a user listening to the fixed-orientation recording).

In some instances, a first user of the first device including the microphone may not be stationary, such that the first sound does not appear to be recorded at a first fixed location and position. For example, the first user wears a first wearable head device including the microphone, and the first user's head is not stationary (e.g., the user's headpose or head orientation changes over time) due to intentional and/or unintentional head movements. By compensating for the first headpose and generating a first fixed-orientation recording, as described herein, a first recording corresponding to the detected sound may be compensated for these movements, as if the sound was detected by a stationary microphone.

In some embodiments, the method 700 includes detecting a second sound (step 702B). For example, sounds are detected by a microphone (e.g., microphone 250; microphones 250A, 250B, 250C, and 250D; microphone of handheld controller 300; microphone array 507) of a second wearable head device or a second AR/MR/XR system. In some embodiments, the sound includes a sound from a sound field or a 3-D audio scene of an AR/MR/XR environment of the second wearable head device or the second AR/MR/XR system. In some embodiments, the AR/MR/XR environment of the second device or system is the same environment as the first device or system, as described with respect to steps 702A-708A.

In some embodiments, the method 700 includes determining a second digital audio signal based on the second detected sound (step 704B). In some embodiments, the second digital audio signal is associated with a second sphere having a second position (e.g., a location, an orientation) in an environment (e.g., an AR, MR, or XR environment). For example, the second spherical signal representation corresponding to the second sounds is derived similarly to a first spherical signal representation, as described with respect to step 704A. For the sake of brevity, this is not described here.

In some embodiments, the method 700 includes detecting a second microphone movement (step 706B). For example, the second microphone movement is detected similarly to detection of a first microphone movement, as described with respect to step 706A. For the sake of brevity, this is not described here.

In some embodiments, the method 700 includes adjusting the second digital audio signal (step 708B). For example, the second headpose is compensated (e.g., using a second function for the second headpose) similarly to compensation of a first headpose, as described with respect to step 708A. For the sake of brevity, this is not described here.

In some embodiments, the method 700 includes generating a second fixed-orientation recording. For example, the second fixed-orientation recording is generated (e.g., by applying the second function to the second spherical signal representation) similarly to generation of a first fixed-orientation recording, as described with respect to step 708A. For the sake of brevity, this is not described here.

After the application of the second function to the second spherical signal representation, a second fixed-orientation recording unaffected by a second user's head orientation and/or movement during recording is generated (e.g., effects of movement during sound detection are unnoticed by a user listening to the second fixed-orientation recording).

In some instances, a second user of the second device including the microphone may not be stationary, such that the second sound does not appear to be recorded at a second fixed location and position. For example, the second user wears a second wearable head device including the microphone, and the second user's head is not stationary (e.g., the user's headpose or head orientation changes over time) due to intentional and/or unintentional head movements. By compensating for the second headpose and generating a second fixed-orientation recording, as described herein, a second recording corresponding to the detected sound may be compensated for these movements, as if the sound was detected by a stationary microphone.

In some embodiments, steps 702A-708A are performed at the same time as steps 702B-708B (e.g., the first device or system and the second device or system are recording a sound field or a 3-D audio scene at a same time). For example, a first user of a first device or system and a second user of a second device or system are recording a sound field or a 3-D audio scene together in the AR/MR/XR environment at a same time. In some embodiments, steps 702A-708A are performed at a different time than steps 702B-708B (e.g., the first device or system and the second device or system are recording a sound field or a 3-D audio scene at a different times). For example, a first user of a first device or system and a second user of a second device or system are recording a sound field or a 3-D audio scene in the AR/MR/XR environment at different times.

In some embodiments, the method 700 includes combining the adjusted digital audio signal and the second adjusted digital audio signal (step 710). For example, the first fixed-orientation recording and the second fixed-orientation recording are combined. The combined first adjusted digital audio signal and second adjusted digital audio signal may be presented to a listener (e.g., in response to a playback request). In some embodiments, the combined fixed-orientation recording includes location and/or position information of the first and second recording devices in the AR/MR/XR environment, and the location and/or position information indicate respective locations and orientations of the first and second recorded sound contents in the AR/MR/XR environment.

In some embodiments, the recordings are combined at a server (e.g., in the cloud) that communicates with the first device or system and the second device or system (e.g., the devices or systems send the respective sound objects to the server for further processing and storage). In some embodiments, the recordings are combined at a master device (e.g., a first or second wearable head device or AR/MR/XR system).

In some embodiments, combining the first and second fixed-orientation recordings produces a combined fixed-orientation recording corresponding to a combined sound field or 3-D audio scene of an environment (e.g., a larger AR/MR/XR environment that requires more than one device for sound detection; the first and second fixed-orientation recordings comprise sounds from different parts of a AR/MR/XR environment) of the first and second recording devices or systems. In some embodiments, the first fixed-orientation recording is an earlier recording of a AR/MR/XR environment, and the second fixed-orientation recording is a later recording of the AR/MR/XR environment. Combining the first and second fixed-orientation recordings allow a sound field or a 3-D audio scene of the AR/MR/XR environment to be updated with new fixed-orientation recordings while achieving the advantages described herein.

In some embodiments, the method 700 advantageously enables producing of a recording of a 3-D audio scene surrounding more than one user (e.g., of more than one wearable head device), and the combined recording is unaffected by the users' head orientations. A recording unaffected by the users' head orientations allows a more accurate audio reproduction of an AR/MR/XR environment, as described in more detail herein.

In some embodiments, using detected data from multiple devices, as described with respect to method 700, may improve location estimation. For instance, correlating data from multiple devices could help provide distance information that may be harder to estimate from a single device audio capture.

Although method 700 is described as comprising movement or headpose compensation for two recordings and combining the two compensated recordings, it is understood that the method 700 may also comprise movement or headpose compensation for one recording and combining a compensated recording and a non-compensated recording. For example, method 700 may be performed to combine a compensated recording and a recording from a fixed recording device (e.g., detecting a recording that does not require compensation).

FIG. 7B illustrates an exemplary method 750 of playing an audio from a sound field according to some embodiments of the disclosure. Although the method 750 is illustrated as including the described steps, it is understood that a different order of steps, additional steps, or fewer steps may be included without departing from the scope of the disclosure. For example, steps of method 750 may be performed with steps of other disclosed methods.

In some embodiments, computation, determination, calculation, or derivation steps of method 750 are performed using a processor (e.g., processor of MR system 112, processor of wearable head device 200A, processor of wearable head device 200B, processor of handheld controller 300, processor of auxiliary unit 400, processor 516, DSP 522) of a wearable head device or an AR/MR/XR system and/or using a server (e.g., in the cloud).

In some embodiments, the method 750 includes combining a first digital audio signal and a second digital audio signal (step 752). For example, a first fixed-orientation recording and a second fixed-orientation recording are combined. In some embodiments, the recordings are combined at a server (e.g., in the cloud) that communicates with the first device or system and the second device or system, and the combined fixed-orientation recording is sent to a playback device (e.g., MR system, wearable head device 200A, wearable head device 200B, handheld controller 300, wearable system 501A, wearable system 501B). In some embodiments, a first digital audio signal and a second digital audio signal are not fixed-orientation recordings.

In some embodiments, the recordings are combined by the playback device. For example, the first and second fixed-orientation recordings are stored at the playback device, and the playback device combines the two fixed-orientation recordings. As another example, at least one of the first and second fixed-orientation recording is received by the playback device (e.g., sent by a second device or system, sent by a server), and the first and second fixed-orientation recordings are combined by the playback device after the playback device stores the fixed-orientation recordings.

In some embodiments, the first fixed-orientation recording and second fixed-orientation recording are combined prior to a playback request. For example, the fixed-orientation recordings are combined at step 710 of method 700 prior to the playback request, and in response to a playback request, the playback device receives the combined fixed-orientation recording. For the sake of brevity, similar examples and advantages between steps 710 and 752 are not described here.

In some embodiments, the method 750 includes downmixing the combined second and third digital audio signal (step 754). For example, the combined fixed-orientation recording is downmixed. For example, the combined fixed-orientation recording from step 752 is downmixed into an audio stream suitable for playback at the playback device (e.g., downmixing the combined fixed-orientation recording into an audio stream comprising a suitable number of corresponding channels (e.g., 2, 5.1, 7.1) for playback at the playback device).

In some embodiments, downmixing the combined fixed-orientation recording comprises applying a respective gain to each of the fixed orientation recording. In some embodiments, downmixing the combined fixed-orientation recording comprises reducing an Ambisonic order corresponding of a respective fixed-orientation recording based on distance of a listener from a recording location of the fixed-orientation recording.

In some embodiments, the method 750 includes receiving a digital audio signal (step 756). In some embodiments, the method 750 includes receiving, at a wearable head device, a digital audio signal. The digital audio signal is associated with a sphere having a position (e.g., a location, an orientation) in the environment. For example, a fixed-orientation recording (e.g., a combined digital audio signal from step 710 or 752, a combined and downmixed combined digital audio signal from step 754) is retrieved by an AR/MR/XR device (e.g., MR system 112, wearable head device 200A, wearable head device 200B, handheld controller 300, wearable system 501A, wearable system 501B). In some embodiments, the recording includes sounds from a sound field or a 3-D audio scene of an AR/MR/XR environment of the wearable head device or an AR/MR/XR system captured and processed by more than one device using the methods described herein. In some embodiment, the recording is a combined fixed-orientation recording (as described herein). The combined fixed-orientation recording is presented to a listener as if the sound of the recording was detected by stationary microphones. In some embodiments, the combined fixed-orientation recording includes location and/or position information of the recording devices (e.g., the first and second recording devices, as described with respect to method 700) in the AR/MR/XR environment, and the location and/or position information indicate respective locations and orientations of the combined recorded sound content in the AR/MR/XR environment. In some embodiments, the retrieved digital audio signal is not a fixed-orientation recording.

In some embodiments, the recording includes combined sounds from a sound field or a 3-D audio scene of an AR/MR/XR environment (e.g., audio of AR/MR/XR content). In some embodiments, the recording includes combined sounds from fixed sound sources of an AR/MR/XR environment (e.g., from a fixed object of the AR/MR/XR environment).

In some embodiments, the recording includes a spherical signal representation (e.g., in Ambisonics format). In some embodiments, the recording is converted into a spherical signal representation (e.g., in Ambisonics format). The spherical signal representation may be advantageously updated to compensate for a user's headpose during audio playback of the recording.

In some embodiments, the method 750 includes detecting a device movement (step 758). For example, in some embodiments, movement of the device is detected, as described with respect to step 654. For the sake of brevity, some examples and advantages are not described here.

In some embodiments, the method 750 includes adjusting the digital audio signal (step 760). For example, in some embodiments, effects of headpose (e.g., of a playback device) are compensated, as described with respect to step 656. For the sake of brevity, some examples and advantages are not described here.

In some embodiments, the method 750 includes presenting the adjusted digital audio signal (step 762). For example, in some embodiments, the adjusted digital audio signal (e.g., compensating for a movement of a playback device) is presented, as described with respect to step 658. For the sake of brevity, some examples and advantages are not described here.

The wearable head device or AR/MR/XR system may play the audio output corresponding to the converted binaural signal or audio signal (e.g., corresponding to a combined recording, an adjusted digital audio signal from step 760), as described with respect to step 658. For the sake of brevity, some examples and advantages are not described here.

In some embodiments, the method 750 advantageously allows a combined 3-D sound field representation (e.g., a 3-D sound field captured by more than one recording device) to be rotated based on a listener's head movement at playback time, before being decoded into a binaural representation for playback. The audio playback would appear to originate from fixed sound sources of an AR/MR/XR environment, providing the user a more realistic AR/MR/XR experience (e.g., fixed AR/MR/XR objects would appear fixed aurally while a user moves relative to the corresponding fixed objects (e.g., changes headpose)).

In some embodiments, when capturing a sound field or a 3-D audio scene, it may be advantageous to separate sound objects and a residual (e.g., portions of the sound field or 3-D audio scene that do not include a sound object) in the sound field or the 3-D audio scene. For example, the sound field or the 3-D audio scene may be a part of AR/MR/XR content that supports six degrees of freedom for a user accessing the AR/MR/XR content. An entire sound field or 3-D audio scene that supports six degrees of freedom may result in very large and/or complex files, which would require more computing resources to access. Therefore, it may be advantageous to extract the sound objects (e.g., sounds associated with objects of interest in an AR/MR/XR environment, dominant sounds in an AR/MR/XR environment) from the sound field or 3-D audio scene and render the sound objects with six-degrees-of-freedom support. The remaining portions (e.g., portions that do not include a sound object such as background noise and sounds) of the sound field or 3-D audio scene may be separated as a residual, and the residual may be rendered with three-degrees-of-freedom support. The sound objects (supporting six degrees of freedom) and the residual (supporting three degrees of freedom) may be combined to generate a less complex (e.g., smaller file sizes) and more efficient sound field or audio scene.

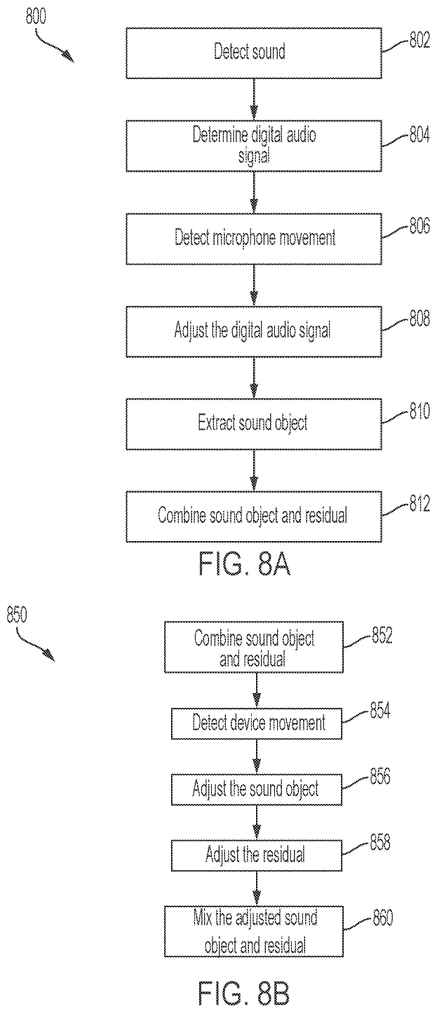

FIG. 8A illustrates an exemplary method 800 of capturing a sound field according to some embodiments of the disclosure. Although the method 800 is illustrated as including the described steps, it is understood that a different order of steps, additional steps, or fewer steps may be included without departing from the scope of the disclosure. For example, steps of method 800 may be performed with steps of other disclosed methods.

In some embodiments, computation, determination, calculation, or derivation steps of method 800 are performed using a processor (e.g., processor of MR system 112, processor of wearable head device 200A, processor of wearable head device 200B, processor of handheld controller 300, processor of auxiliary unit 400, processor 516, DSP 522) of a wearable head device or an AR/MR/XR system and/or using a server (e.g., in the cloud).

In some embodiments, the method 800 includes detecting a sound (step 802). For example, a sound is detected, as described with respect to step 602, 702A, or 702B. For the sake of brevity, some examples and advantages are not described here.

In some embodiments, the method 800 includes determining a digital audio signal based on the detected sound (step 804). In some embodiments, the digital audio signal is associated with a sphere having a position (e.g., a location, an orientation) in an environment (e.g., an AR, MR, or XR environment). For example, a spherical signal representation is derived, as described with respect to step 604, 704A, or 704B. For the sake of brevity, some examples and advantages are not described here.

In some embodiments, the method 800 includes detecting a microphone movement (step 806). For example, movement of a microphone is detected, as described with respect to step 606, 706A, or 706B. For the sake of brevity, some examples and advantages are not described here.

In some embodiments, the method 800 includes adjusting the digital audio signal (step 808). For example, effects of headpose are compensated, as described with respect to step 608, 708A, or 708B. For the sake of brevity, some examples and advantages are not described here.

In some embodiments, the method 800 includes generating a fixed-orientation recording. For example, a fixed-orientation recording is generated, as described with respect to step 608, 708A, or 708B. For the sake of brevity, some examples and advantages are not described here.

In some embodiments, the method 800 includes extracting a sound object (step 810). For example, the sound object correspond to a sound associated with an object of interest in an AR/MR/XR environment or to dominant sounds in an AR/MR/XR environment. In some embodiments, a processor (e.g., processor of MR system 112, processor of wearable head device 200A, processor of wearable head device 200B, processor of handheld controller 300, processor of auxiliary unit 400, processor 516, DSP 522) of a wearable head device or an AR/MR/XR system determines the sound objects in a sound field or an audio scene and extracts the sound objects from the sound field or audio scene. In some embodiments, the extracted sound object comprises audio (e.g., audio signals associated with the sound) and location and position information (e.g., coordinates and orientation of a sound source associated with the sound object in the AR/MR/XR environment).

In some embodiments, a sound object comprises a portion of a detected sounds, and the portion meets a sound object criterion. For example, a sound object determined based on an activity of a sound. In some embodiments, the device or the system determines objects having a sound activity (e.g., frequency change, displacement in the environment, amplitude change) above a threshold sound activity (e.g., above a threshold frequency change, above a threshold displacement in the environment, above a threshold amplitude change). For example, the environment is a virtual concert, and the sound field includes sounds of an electric guitar and noises of the virtual spectators. The device or system may determine that the sounds of an electric guitar, in accordance with a determination that the sounds of the electric guitar have a sound activity above a threshold sound activity (e.g., a speedy musical passage is being played on the electric guitar), are sound objects are extracted accordingly, and the noise of the virtual spectators is part of a residual (as described in more detail herein).

In some embodiments, the sound objects are determined by information of the AR/MR/XR environment (e.g., the information of the AR/MR/XR environment defines the objects of interest or dominant sounds and their corresponding sounds). In some embodiments, the sound objects are user-defined (e.g., while recording a sound field or an audio scene, the user defines the objects of interest or dominant sounds in the environment and their corresponding sounds).

In some embodiments, sounds of a virtual object may be sound objects at a first time and a residue at a second time. For example, at the first time, the device or system determines that a sound of the virtual object is a sound object (e.g., above a threshold sound activity) and extracts the sound object. However, at the second time, the device or system determines that a sound of the virtual object is not a sound object (e.g., below a threshold sound activity) and does not extract the sound object (e.g., the sound of the virtual object is part of the residual at the second time).

In some embodiments, the method 800 includes combining the sound object and a residual (step 812). For example, the wearable head device or AR/MR/XR system combines the extracted sound objects (e.g., from step 810) and the residual (e.g., portions of the sound field or audio scene not extracted as sound objects). In some embodiments, the combined sound objects and residual is a less complex and more efficient sound field or audio scene, compared to a sound field or audio scene without sound object extraction. In some embodiments, the residual is stored with lower spatial resolution (e.g., in a 1st order Ambisonics file). In some embodiments, a sound object is stored with higher spatial resolution (e.g., because the sound object comprises a sound of an object of interest or a dominant sound in an AR/MR/XR environment).

In some examples, the sound field or the 3-D audio scene may be a part of AR/MR/XR content that supports six degrees of freedom for a user accessing the AR/MR/XR content. In some embodiments, the sound objects (e.g., sounds associated with objects of interest in an AR/MR/XR environment, dominant sounds in an AR/MR/XR environment) from the sound field or 3-D audio scene are rendered (e.g., by a processor of a wearable head device or an AR/MR/XR system) with six-degrees-of-freedom support. The remaining portions (e.g., portions that do not include a sound object such as background noise and sounds) of the sound field or 3-D audio scene may be separated as a residual, and the residual may be rendered with three-degrees-of-freedom support. The sound objects (supporting six degrees of freedom) and the residual (supporting three degrees of freedom) may be combined to generate a less complex (e.g., smaller file sizes) and more efficient sound field or audio scene.

In some embodiments, the method 800 advantageously generates a less complex (e.g., smaller file sizes) sound field or audio scene. By extracting sound objects and rendering them at higher spatial resolution, while rendering the residual at a lower spatial resolution, the generated sound field or audio scene is more efficient (e.g., smaller file sizes, less required computational resources) than an entire sound field or audio scene that supports six degrees of freedom. Furthermore, while being more efficient, the generated sound field or audio scene does not compromise a user's AR/MR/XR experience by maintaining the more important qualities of a six-degrees-of-freedom sound field or audio scene while minimizing resources on portions that do not require more degrees of freedom.

FIG. 8B illustrates an exemplary method 850 of playing an audio from a sound field according to some embodiments of the disclosure. Although the method 850 is illustrated as including the described steps, it is understood that a different order of steps, additional steps, or fewer steps may be included without departing from the scope of the disclosure. For example, steps of method 850 may be performed with steps of other disclosed methods.

In some embodiments, computation, determination, calculation, or derivation steps of method 850 are performed using a processor (e.g., processor of MR system 112, processor of wearable head device 200A, processor of wearable head device 200B, processor of handheld controller 300, processor of auxiliary unit 400, processor 516, DSP 522) of a wearable head device or an AR/MR/XR system and/or using a server (e.g., in the cloud).

In some embodiments, the method 850 includes combining a sound object and a residual (step 852). For example, a sound object and a residual are combined, as described with respect step 812. For the sake of brevity, some examples and advantages are not described here.

In some embodiments, the sound object and the residual are combined prior to a playback request. For example, the sound object and the residual are combined at step 812 while method 800 is performed, prior to the playback request, and in response to a playback request, the playback device receives the combined sound objects and the residual.

In some embodiments, the method 850 includes detecting a device movement (step 854). For example, in some embodiments, movement of a device is detected, as described with respect to step 654 or step 758. For the sake of brevity, some examples and advantages are not described here.

In some embodiments, the method 850 includes adjusting the sound object (step 856). In some embodiments, the sound object is associated with a first sphere having a first position in the environment. For example, in some embodiments, effects of headpose are compensated for a sound object, as described with respect to step 656 or step 760. For the sake of brevity, some examples and advantages are not described here.

As an example, a sound object supports six degrees of freedom. Due to the sound object's high spatial resolution, effects of headpose along these six degrees of freedom may be advantageously compensated. For instance, headpose movement along any of the six degrees of freedom may be compensated, such that the sound object appears to originate from a fixed sound source in an AR/MR/XR environment, even if a headpose moves along any of the six degrees of freedom.

In some embodiments, the method 850 includes converting a sound object to first binaural signal. For example, the playback device (e.g., a wearable head device, an AR/MR/XR system) converts a sound object to a binaural signal. In some embodiments, all of the sound objects (e.g., extracted as described herein) are converted into respective binaural signals. In some embodiments, each sound object is converted one at a time. In some embodiments, more than one sound object are converted at a same time.

In some embodiments, the method 850 includes adjusting the residual (step 858). In some embodiments, the residual is associated with a second sphere having a second position in the environment. For example, in some embodiments, effects of headpose are compensated for a residual, as described with respect to step 654 or step 758. For the sake of brevity, some examples and advantages are not described here. In some embodiments, the residual is stored with lower spatial resolution (e.g., in a 1st order Ambisonics file).

In some embodiments, the method 850 includes converting a residual to second binaural signal. For example, the playback device (e.g., a wearable head device, an AR/MR/XR system) converts a residual (as described herein) to a binaural signal.

In some embodiments, the steps 856 and 858 are performed in parallel (e.g., the sound objects and the residual are converted at a same time). In some embodiments, the steps 856 and 858 are performed sequentially (e.g., the sound objects are converted first, then the residual; the residual is converted first, then the sound objects).

In some embodiments, the method 850 includes mixing the adjusted sound object and the adjusted residual (step 860). For example, the first (e.g., the adjusted sound object) and second binaural signals (e.g., the adjusted residual) are mixed. For example, after the sound objects and the residual are converted into respective binaural signals, the playback device (e.g., a wearable head device, an AR/MR/XR system) mixes the binaural signals into an audio stream for presentation to a listener of the device. In some embodiments, the audio stream comprises sounds in an AR/MR/XR environment of the playback device.

In some embodiments, the method 850 includes presenting the mixed adjusted sound object and residual (step 864). In some embodiments, the method 850 includes presenting the mixed adjusted sound object and residual to a user of the wearable head device via one or more speakers of the wearable head device. For example, the audio stream mixed from the first and second binaural signals is played by a playback device (e.g., a wearable head device, an AR/MR/XR system). In some embodiments, the audio stream comprises sounds in an AR/MR/XR environment of the playback device. For the sake of brevity, some examples and advantages of presenting an adjusted digital audio signal are not described here.

In some embodiments, due to the extraction of sound objects, the audio stream is less complex (e.g., smaller file sizes), compared to an audio stream that does not have corresponding extracted sound objects and a residual. By extracting sound objects and rendering them at higher spatial resolution, while rendering the residual at a lower spatial resolution, the audio stream is more efficient (e.g., smaller file sizes, less required computational resources) than sound field or audio scene including portions that support unnecessary degrees of freedom. Furthermore, while being more efficient, the audio stream does not compromise a user's AR/MR/XR experience by maintaining the more important qualities of a six-degrees-of-freedom sound field or audio scene while minimizing resources on portions that do not require more degrees of freedom.

In some embodiments, the method 800 may be performed using more than one device or system. That is, more than one device or system may capture a sound field or audio scene, and sound objects and residuals may be extracted from the sound fields or audio scenes detected by more than one device or system.

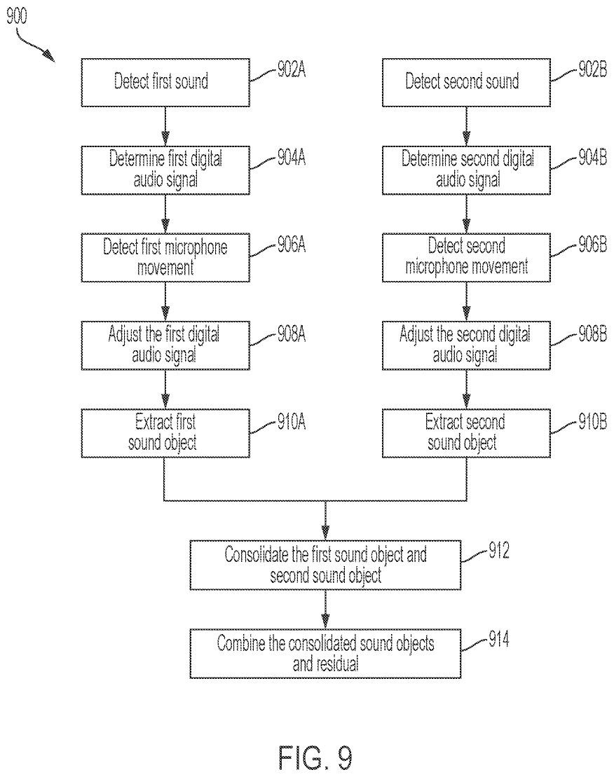

FIG. 9 illustrates an exemplary method 900 of capturing a sound field according to some embodiments of the disclosure. Although the method 900 is illustrated as including the described steps, it is understood that a different order of steps, additional steps, or fewer steps may be included without departing from the scope of the disclosure. For example, steps of method 900 may be performed with steps of other disclosed methods.

In some embodiments, computation, determination, calculation, or derivation steps of method 900 are performed using a processor (e.g., processor of MR system 112, processor of wearable head device 200A, processor of wearable head device 200B, processor of handheld controller 300, processor of auxiliary unit 400, processor 516, DSP 522) of a wearable head device or an AR/MR/XR system and/or using a server (e.g., in the cloud).

In some embodiments, the method 900 includes detecting a first sound (step 902A). For example, a sound is detected by a microphone (e.g., microphone 250; microphones 250A, 250B, 250C, and 250D; microphone of handheld controller 300; microphone array 507) of a first wearable head device or a first AR/MR/XR system. In some embodiments, the sound includes a sound from a sound field or a 3-D audio scene of an AR/MR/XR environment of the first wearable head device or the first AR/MR/XR system

In some embodiments, the method 900 includes determining a first digital audio signal based on the first detected sound (step 904A). In some embodiments, the first digital audio signal is associated with a first sphere having a first position (e.g., a location, an orientation) in an environment (e.g., an AR, MR, or XR environment). For example, the first spherical signal corresponding to the first sounds is derived similarly to a first spherical signal representation, as described with respect to step 704A. For the sake of brevity, this is not described here.

In some embodiments, the method 900 includes detecting a first microphone movement (step 906A). For example, the first microphone movement is detected similarly to detection of a first microphone movement, as described with respect to step 706A. For the sake of brevity, this is not described here.

In some embodiments, the method 900 includes adjusting the first digital audio signal (step 908A). For example, the first headpose is compensated (e.g., using a first function for the first headpose) similarly to compensation of a first headpose, as described with respect to step 708A. For the sake of brevity, this is not described here.

In some embodiments, the method 900 includes generating a first fixed-orientation recording. For example, the first fixed-orientation recording is generated (e.g., by applying the first function to the first spherical signal representation) similarly to generation of a first fixed-orientation recording, as described with respect to step 708A. For the sake of brevity, this is not described here.

In some embodiments, the method 900 includes extracting a first sound object (step 910A). For example, the first sound object correspond to a sound associated with an object of interest or dominant sounds in an AR/MR/XR environment detected by the first recording device. In some embodiments, a processor (e.g., processor of MR system 112, processor of wearable head device 200A, processor of wearable head device 200B, processor of handheld controller 300, processor of auxiliary unit 400, processor 516, DSP 522) of a first wearable head device or a first AR/MR/XR system determines the first sound objects in a sound field or an audio scene and extracts the sound objects from the sound field or audio scene. In some embodiments, the extracted first sound object comprises audio (e.g., audio signals associated with the sound) and location and position information (e.g., coordinates and orientation of a sound source associated with the first sound object in the AR/MR/XR environment). For the sake of brevity, some examples and advantages of sound object extraction (e.g., described with respect to step 810) are not described here.

In some embodiments, the method 900 includes detecting a second sound (step 902B). For example, a sound are detected by a microphone (e.g., microphone 250; microphones 250A, 250B, 250C, and 250D; microphone of handheld controller 300; microphone array 507) of a second wearable head device or a second AR/MR/XR system. In some embodiments, the sound includes a sound from a sound field or a 3-D audio scene of an AR/MR/XR environment of the second wearable head device or the second AR/MR/XR system. In some embodiments, the AR/MR/XR environment of the second device or system is the same environment as the first device or system, as described with respect to steps 902A-910A.

In some embodiments, the method 900 includes determining a second digital audio signal based on the second detected sound (step 904B). For example, the second spherical signal representation corresponding to the second sounds is derived similarly to a spherical signal representation, as described with respect to step 704A, 704B, or 904A. For the sake of brevity, this is not described here.

In some embodiments, the method 900 includes detecting a second microphone movement (step 906B). For example, the second microphone movement is detected similarly to detection of a second microphone movement, as described with respect to step 706B or 906A. For the sake of brevity, this is not described here.

In some embodiments, the method 900 includes adjusting the second digital audio signal (step 908B). For example, the second headpose is compensated (e.g., using a second function for the second headpose) similarly to compensation of a second headpose, as described with respect to step 708A, 708B, or 908A. For the sake of brevity, this is not described here.

In some embodiments, the method 900 includes generating a second fixed-orientation recording. For example, the second fixed-orientation recording is generated (e.g., by applying the second function to the second spherical signal representation) similarly to generation of a fixed-orientation recording, as described with respect to step 708A, 708B, or 908A. For the sake of brevity, this is not described here.

In some embodiments, the method 900 includes extracting second sound objects (step 910B). For example, a second sound object is extracted similarly to extraction of a first sound object, as described with respect to step 910A. For the sake of brevity, this is not described here.

In some embodiments, steps 902A-910A are performed at the same time as steps 902B-910B (e.g., the first device or system and the second device or system are recording a sound field or a 3-D audio scene at a same time). For example, a first user of a first device or system and a second user of a second device or system are recording a sound field or a 3-D audio scene together in the AR/MR/XR environment at a same time. In some embodiments, steps 902A-910A are performed at a different time than steps 902B-910B (e.g., the first device or system and the second device or system are recording a sound field or a 3-D audio scene at a different times). For example, a first user of a first device or system and a second user of a second device or system are recording a sound field or a 3-D audio scene in the AR/MR/XR environment at different times.

In some embodiments, the method 900 includes consolidating the first sound objects and the second objects (step 912). For example, the first and second sound objects are consolidated by grouping into a single larger group of sound objects. Consolidation of the sound objects allow the sound objects to be more efficiently combined with the residual in the next step.

In some embodiments, the first and second sound objects are consolidated at a server (e.g., in the cloud) that communicates with the first device or system and the second device or system (e.g., the devices or systems send the respective sound objects to the server for further processing and storage). In some embodiments, the first and second sound objects are consolidated at a master device (e.g., a first or second wearable head device or AR/MR/XR system).

In some embodiments, the method 900 includes combining the consolidated sound objects and a residual (step 914). For example, a server (e.g., in the cloud) or a master device (e.g., a first or second wearable head device or AR/MR/XR system) combines the extracted sound objects (e.g., from step 914) and a residual (e.g., portions of the sound field or audio scene not extracted as sound objects; determined from the respective sound object extraction steps 910A and 910B). In some embodiments, the combined sound objects and residual is a less complex and more efficient sound field or audio scene, compared to a sound field or audio scene without sound object extraction. In some embodiments, the residual is stored with lower spatial resolution (e.g., in a 1^{st} order Ambisonics file). In some embodiments, a sound object is stored with higher spatial resolution (e.g., because the sound object comprises a sound of an object of interest or a dominant sound in an AR/MR/XR environment). For the sake of brevity, some examples and advantages of combining sound objects and the residual are not described here.

In some embodiments, the method 900 advantageously generates a less complex (e.g., smaller file sizes) sound field or audio scene. By extracting sound objects and rendering them at higher spatial resolution, while rendering the residual at a lower spatial resolution, the generated sound field or audio scene is more efficient (e.g., smaller file sizes, less required computational resources) than an entire sound field or audio scene that supports six degrees of freedom. Furthermore, while being more efficient, the generated sound field or audio scene does not compromise a user's AR/MR/XR experience by maintaining the more important qualities of a six-degrees-of-freedom sound field or audio scene while minimizing resources on portions that do not require more degrees of freedom. This advantage becomes greater for larger sound fields or audio scenes, which may require more than one recording device for sound detection, such as the exemplary sound fields or audio scenes described with respect to method 900.

In some embodiments, using detected data from multiple devices, as described with respect to method 900, may allow improved extraction of sound objects with more accurate location estimation. For instance, correlating data from multiple devices could help provide distance information that may be harder to estimate from a single device audio capture.

In some embodiments, a wearable head device (e.g., a wearable head device described herein, AR/MR/XR system described herein) includes: a processor; a memory; and a program stored in the memory, configured to be executed by the processor, and including instructions for performing the methods described with respect to FIGS. 6-9.

In some embodiments, a non-transitory computer readable storage medium stores one or more programs, and the one or more programs includes instructions. When the instructions are executed by an electronic device (e.g., an electronic device or system described herein) with one or more processors and memory, the instructions cause the electronic device to perform the methods described with respect to FIGS. 6-9.

Although examples of the disclosure are described with respect to a wearable head device or an AR/MR/XR system, it is understood that the disclosed sound field recording and playback methods may also be performed using other devices or systems. For example, the disclosed methods may be performed using a mobile device for compensating for effects of movement during recording or playback. As another example, the disclosed methods may be performed using a mobile device for recording a sound field including extracting sound objects and combining the sound objects and a residual.

Although examples of the disclosure are described with respect to headpose compensation, it is understood that the disclosed sound field recording and playback methods may also be performed generally for compensation of any movement. For example, the disclosed methods may be performed using a mobile device for compensating for effects of movement during recording or playback.

With respect to the systems and methods described herein, elements of the systems and methods can be implemented by one or more computer processors (e.g., CPUs or DSPs) as appropriate. The disclosure is not limited to any particular configuration of computer hardware, including computer processors, used to implement these elements. In some cases, multiple computer systems can be employed to implement the systems and methods described herein. For example, a first computer processor (e.g., a processor of a wearable device coupled to one or more microphones) can be utilized to receive input microphone signals, and perform initial processing of those signals (e.g., signal conditioning and/or segmentation). A second (and perhaps more computationally powerful) processor can then be utilized to perform more computationally intensive processing, such as determining probability values associated with speech segments of those signals. Another computer device, such as a cloud server, can host an audio processing engine, to which input signals are ultimately provided. Other suitable configurations will be apparent and are within the scope of the disclosure.

According to some embodiments, a method comprises: detecting, with a microphone of a first wearable head device, a sound of an environment; determining a digital audio signal based on the detected sound, the digital audio signal associated with a sphere having a position in the environment; concurrently with detecting the sound, detecting, via a sensor of the first wearable head device, a microphone movement with respect to the environment; adjusting the digital audio signal, wherein the adjusting comprises adjusting the position of the sphere based on based on the detected microphone movement (e.g., magnitude, direction); and presenting the adjusted digital audio signal to a user of a second wearable head device via one or more speakers of the second wearable head device.

According to some embodiments, the method further comprises: detecting, with a microphone of a third wearable head device, a second sound of the environment; determining a second digital audio signal based on the second detected sound, the second digital audio signal associated with a second sphere having a second position in the environment; concurrently, with detecting the second sound, detecting, via a sensor of the third wearable head device, a second microphone movement with respect to the environment; adjusting the second digital audio signal, wherein the adjusting comprises adjusting the second position of the second sphere based on based on the second detected microphone movement; combining the adjusted digital audio signal and the second adjusted digital audio signal; and presenting the combined first adjusted digital audio signal and second adjusted digital audio signal to the user of the second wearable head device via the one or more speakers of the second wearable head device.

According to some embodiments, the first adjusted digital audio signal and the second adjusted digital audio signal are combined at a server.

According to some embodiments, the digital audio signal comprises an Ambisonic file.

According to some embodiments, detecting the microphone movement with respect to the environment comprises performing one or more of simultaneous localization and mapping and visual inertial odometry.

According to some embodiments, the sensor comprises one or more of an inertial measurement unit, a camera, a second microphone, a gyroscope, and a LiDAR sensor.

According to some embodiments, adjusting the digital audio signal comprises applying a compensation function to the digital audio signal.

According to some embodiments, wherein applying the compensation function comprises applying the compensation function based on an inverse of the microphone movement.

According to some embodiments, the method further comprises concurrently, with presenting the adjusted digital audio signal, displaying, on a display of the second wearable head device, content associated with the sound of the environment.

According to some embodiments, a method comprises: receiving, at a wearable head device, a digital audio signal, the digital audio signal associated with a sphere having a position in the environment; detecting, via a sensor of the wearable head device, a device movement with respect to the environment; adjusting the digital audio signal, wherein the adjusting comprises adjusting the position of the sphere based on based on the detected device movement; and presenting the adjusted digital audio signal to a user of the wearable head device via one or more speakers of the wearable head device.

According to some embodiments, the method further comprises: combining a second digital audio signal and a third digital audio signal; and downmixing the combined second and third digital audio signal, wherein the retrieved first digital audio signal is the combined second and third digital audio signal.

According to some embodiments, downmixing the combined second and third digital audio signal comprises applying a first gain to the second digital audio signal and a second gain to the second digital audio signal.

According to some embodiments, downmixing the combined second and third digital audio signal comprises reducing an Ambisonic order of the second digital audio signal based on a distance of the wearable head device from a recording location of the second digital audio signal.

According to some embodiments, the sensor is an inertial measurement unit, a camera, a second microphone, a gyroscope, or a LiDAR sensor.

According to some embodiments, detecting the device movement with respect to the environment comprises performing simultaneous localization and mapping or visual inertial odometry.

According to some embodiments, adjusting the digital audio signal comprises applying a compensation function to the digital audio signal.

According to some embodiments, wherein applying the compensation function comprises applying the compensation function based on an inverse of the microphone movement.

According to some embodiments, the digital audio signal is in Ambisonics format.

According to some embodiments, the method further comprises concurrently, with presenting the adjusted digital audio signal, displaying, on a display of the wearable head device, content associated with a sound of the digital audio signal in the environment.

According to some embodiments, a method comprises: detecting sounds of an environment; extracting a sound object from the detected sounds; and combining the sound objects and a residual. The sound object comprises a first portion of the detected sounds, the first portion meeting a sound object criterion, and the residual comprises a second portion of the detected sounds, the second portion not meeting the sound object criterion.

According to some embodiments, the further comprises: detecting second sounds of the environment; determining whether a portion of the second detected sounds meets the sound object criterion, wherein: a portion of the second detected sounds meeting the sound object criterion comprises a second sound object, and a portion of the second detected sounds not meeting the sound object criterion comprises a second residual; extracting the second sound object from the second detected sounds; and consolidating the first sound object and the second sound object, wherein combining the sound object and the residual comprises combining the consolidated sound object, the first residual, and the second residual.

According to some embodiments, the sound object supports six degrees of freedom in the environment, and the residual supports three degrees of freedom in the environment.

According to some embodiments, the sound object has a higher spatial resolution than the residual.

According to some embodiments, the residual is stored in a lower order Ambisonic file.

According to some embodiments, a method, comprises: detecting, via a sensor of a wearable head device, a device movement with respect to the environment; adjusting a sound object, wherein the sound object is associated with a first sphere having a first position in the environment and the adjusting comprises adjusting the first position of the first sphere based on based on the detected device movement; adjusting a residual, wherein the residual is associated with a second sphere having a second position in the environment and the adjusting comprises adjusting the second position of the second sphere based on based on the detected device movement; mixing the adjusted sound object and the adjusted residual; and presenting the mixed adjusted sound object and adjusted residual to a user of the wearable head device via one or more speakers of the wearable head device.

According to some embodiments, a system comprises: a first wearable head device comprising a microphone and a sensor; a second wearable head device comprising a speaker; and one or more processors configured to execute a method comprising: detecting, with the microphone of the first wearable head device, a sound of an environment; determining a digital audio signal based on the detected sound, the digital audio signal associated with a sphere having a position in the environment; concurrently with detecting the sound, detecting, via the sensor of the first wearable head device, a microphone movement with respect to the environment; adjusting the digital audio signal, wherein the adjusting comprises adjusting the position of the sphere based on based on the detected microphone movement; and presenting the adjusted digital audio signal to a user of the second wearable head device via the speaker of the second wearable head device.

According to some embodiments, the system further comprises a third wearable head device comprising a microphone and a sensor, wherein the method further comprises: detecting, with the microphone of the third wearable head device, a second sound of the environment; determining a second digital audio signal based on the second detected sound, the second digital audio signal associated with a second sphere having a second position in the environment; concurrently, with detecting the second sound, detecting, via the sensor of the third wearable head device, a second microphone movement with respect to the environment; adjusting the second digital audio signal, wherein the adjusting comprises adjusting the second position of the second sphere based on based on the second detected microphone movement; combining the adjusted digital audio signal and the second adjusted digital audio signal; and presenting the combined first adjusted digital audio signal and second adjusted digital audio signal to the user of the second wearable head device via the speaker of the second wearable head device.

According to some embodiments, the first adjusted digital audio signal and the second adjusted digital audio signal are combined at a server.

According to some embodiments, the digital audio signal comprises an Ambisonic file.

According to some embodiments, detecting the microphone movement with respect to the environment comprises one or more of performing simultaneous localization and mapping and visual inertial odometry.

According to some embodiments, the sensor comprises one of more of an inertial measurement unit, a camera, a second microphone, a gyroscope, and a LiDAR sensor.

According to some embodiments, adjusting the digital audio signal comprises applying a compensation function to the digital audio signal.

According to some embodiments, wherein applying the compensation function comprises applying the compensation function based on an inverse of the microphone movement.

According to some embodiments, the method further comprises concurrently, with presenting the adjusted digital audio signal, displaying, on a display of the second wearable head device, content associated with the sound of the environment.

According to some embodiments, a system comprises: a wearable head device comprising a sensor and a speaker; and one or more processors configured to execute a method comprising: receiving, at the wearable head device, a digital audio signal, the digital audio signal associated with a sphere having a position in the environment; detecting, via the sensor of the wearable head device, a device movement with respect to the environment; adjusting the digital audio signal, wherein the adjusting comprises adjusting the position of the sphere based on based on the detected device movement; and presenting the adjusted digital audio signal to a user of the wearable head device via the speaker of the wearable head device.

According to some embodiments, the method further comprises: combining a second digital audio signal and a third digital audio signal; and downmixing the combined second and third digital audio signal, wherein the retrieved first digital audio signal is the combined second and third digital audio signal.

According to some embodiments, downmixing the combined second and third digital audio signal comprises applying a first gain to the second digital audio signal and a second gain to the second digital audio signal.

According to some embodiments, downmixing the combined second and third digital audio signal comprises reducing an Ambisonic order of the second digital audio signal based on a distance of the wearable head device from a recording location of the second digital audio signal.

According to some embodiments, the sensor is an inertial measurement unit, a camera, a second microphone, a gyroscope, or a LiDAR sensor.

According to some embodiments, detecting the device movement with respect to the environment comprises performing simultaneous localization and mapping or visual inertial odometry.

According to some embodiments, adjusting the digital audio signal comprises applying a compensation function to the digital audio signal.

According to some embodiments, wherein applying the compensation function comprises applying the compensation function based on an inverse of the microphone movement.

According to some embodiments, the digital audio signal is in Ambisonics format.

According to some embodiments, the wearable head device further comprises a display, and the method further comprises concurrently, with presenting the adjusted digital audio signal, displaying, on the display of the wearable head device, content associated with a sound of the digital audio signal in the environment.

According to some embodiments, a system comprises one or more processors configured to execute a method comprising: detecting sounds of an environment; extracting a sound object from the detected sounds; and combining the sound objects and a residual. The sound object comprises a first portion of the detected sounds, the first portion meeting a sound object criterion, and the residual comprises a second portion of the detected sounds, the second portion not meeting the sound object criterion.

According to some embodiments, the method further comprises: detecting second sounds of the environment; determining whether a portion of the second detected sounds meets the sound object criterion, wherein: a portion of the second detected sounds meeting the sound object criterion comprises a second sound object, and a portion of the second detected sounds not meeting the sound object criterion comprises a second residual; extracting the second sound object from the second detected sounds; and consolidating the first sound object and the second sound object, wherein combining the sound object and the residual comprises combining the consolidated sound object, the first residual, and the second residual.

According to some embodiments, the sound object supports six degrees of freedom in the environment, and the residual supports three degrees of freedom in the environment.

According to some embodiments, the sound object has a higher spatial resolution than the residual.

According to some embodiments, the residual is stored in a lower order Ambisonic file.

According to some embodiments, a system comprises: a wearable head device comprising a sensor and a speaker; and one or more processors configured to execute a method comprising: detecting, via the sensor of the wearable head device, a device movement with respect to the environment; adjusting a sound object, wherein the sound object is associated with a first sphere having a first position in the environment and the adjusting comprises adjusting the first position of the first sphere based on based on the detected device movement; adjusting a residual, wherein the residual is associated with a second sphere having a second position in the environment and the adjusting comprises adjusting the second position of the second sphere based on based on the detected device movement; mixing the adjusted sound object and the adjusted residual; and presenting the mixed adjusted sound object and adjusted residual to a user of the wearable head device via the speaker of the wearable head device.

According to some embodiments, a non-transitory computer-readable medium stores one or more instructions, which, when executed by one or more processors of an electronic device, cause the device to perform a method comprising: detecting, with a microphone of a first wearable head device, a sound of an environment; determining a digital audio signal based on the detected sound, the digital audio signal associated with a sphere having a position in the environment; concurrently with detecting the sound, detecting, via a sensor of the first wearable head device, a microphone movement with respect to the environment; adjusting the digital audio signal, wherein the adjusting comprises adjusting the position of the sphere based on based on the detected microphone movement; and presenting the adjusted digital audio signal to a user of a second wearable head device via one or more speakers of the second wearable head device.

According to some embodiments, the method further comprises: detecting, with a microphone of a third wearable head device, a second sound of the environment; determining a second digital audio signal based on the second detected sound, the second digital audio signal associated with a second sphere having a second position in the environment; concurrently, with detecting the second sound, detecting, via a sensor of the third wearable head device, a second microphone movement with respect to the environment; adjusting the second digital audio signal, wherein the adjusting comprises adjusting the second position of the second sphere based on based on the second detected microphone movement; combining the adjusted digital audio signal and the second adjusted digital audio signal; and presenting the combined first adjusted digital audio signal and second adjusted digital audio signal to the user of the second wearable head device via the speaker of the second wearable head device.

According to some embodiments, the first digital audio signal and the second digital audio signal are combined at a server.

According to some embodiments, the digital audio signal comprises an Ambisonic file.

According to some embodiments, detecting the microphone movement with respect to the environment comprises performing one or more of simultaneous localization and mapping and visual inertial odometry.

According to some embodiments, the sensor comprises one of more of an inertial measurement unit, a camera, a second microphone, a gyroscope, and a LiDAR sensor.

According to some embodiments, adjusting the digital audio signal comprises applying a compensation function to the digital audio signal.

According to some embodiments, wherein applying the compensation function comprises applying the compensation function based on an inverse of the microphone movement.

According to some embodiments, the method further comprises concurrently, with presenting the adjusted digital audio signal, displaying, on a display of the second wearable head device, content associated with the sound of the environment.

According to some embodiments, a non-transitory computer-readable medium stores one or more instructions, which, when executed by one or more processors of an electronic device, cause the device to perform a method comprising: receiving, at a wearable head device, a digital audio signal, the digital audio signal associated with a sphere having a position in the environment; detecting, via a sensor of the wearable head device, a device movement with respect to the environment; adjusting the digital audio signal, wherein the adjusting comprises adjusting the position of the sphere based on based on the detected device movement; and presenting the adjusted digital audio signal to a user of the wearable head device via one or more speakers of the wearable head device.

According to some embodiments, the method further comprises: combining a second digital audio signal and a third digital audio signal; and downmixing the combined second and third digital audio signal, wherein the retrieved first digital audio signal is the combined second and third digital audio signal.

According to some embodiments, downmixing the combined second and third digital audio signal comprises applying a first gain to the second digital audio signal and a second gain to the second digital audio signal.

According to some embodiments, downmixing the combined second and third digital audio signal comprises reducing an Ambisonic order of the second digital audio signal based on a distance of the wearable head device from a recording location of the second digital audio signal.

According to some embodiments, the sensor is an inertial measurement unit, a camera, a second microphone, a gyroscope, or a LiDAR sensor.

According to some embodiments, detecting the device movement with respect to the environment comprises performing simultaneous localization and mapping or visual inertial odometry.

According to some embodiments, adjusting the digital audio signal comprises applying a compensation function to the digital audio signal.

According to some embodiments, wherein applying the compensation function comprises applying the compensation function based on an inverse of the microphone movement.

According to some embodiments, the digital audio signal is in Ambisonics format.

According to some embodiments, the method further comprises concurrently, with presenting the adjusted digital audio signal, displaying, on a display of the wearable head device, content associated with a sound of the digital audio signal in the environment.

According to some embodiments, a non-transitory computer-readable medium stores one or more instructions, which, when executed by one or more processors of an electronic device, cause the device to perform a method comprising: detecting sounds of an environment; extracting a sound object from the detected sounds; and combining the sound objects and a residual. The sound object comprises a first portion of the detected sounds, the first portion meeting a sound object criterion, and the residual comprises a second portion of the detected sounds, the second portion not meeting the sound object criterion.

According to some embodiments, the method further comprises: detecting second sounds of the environment; determining whether a portion of the second detected sounds meets the sound object criterion, wherein: a portion of the second detected sounds meeting the sound object criterion comprises a second sound object, and a portion of the second detected sounds not meeting the sound object criterion comprises a second residual; extracting the second sound object from the second detected sounds; and consolidating the first sound object and the second sound object, wherein combining the sound object and the residual comprises combining the consolidated sound object, the first residual, and the second residual.

According to some embodiments, the sound object supports six degrees of freedom in the environment, and the residual supports three degrees of freedom in the environment.

According to some embodiments, the sound object has a higher spatial resolution than the residual.

According to some embodiments, the residual is stored in a lower order Ambisonic file.

According to some embodiments, a non-transitory computer-readable medium stores one or more instructions, which, when executed by one or more processors of an electronic device, cause the device to perform a method comprising: detecting, via a sensor of a wearable head device, a device movement with respect to the environment; adjusting a sound object, wherein the sound object is associated with a first sphere having a first position in the environment and the adjusting comprises adjusting the first position of the first sphere based on based on the detected device movement; adjusting a residual, wherein the residual is associated with a second sphere having a second position in the environment and the adjusting comprises adjusting the second position of the second sphere based on based on the detected device movement; mixing the adjusted sound object and the adjusted residual; and presenting the mixed adjusted sound object and adjusted residual to a user of the wearable head device via one or more speakers of the wearable head device.

Although the disclosed examples have been fully described with reference to the accompanying drawings, it is to be noted that various changes and modifications will become apparent to those skilled in the art. For example, elements of one or more implementations may be combined, deleted, modified, or supplemented to form further implementations. Such changes and modifications are to be understood as being included within the scope of the disclosed examples as defined by the appended claims.

What is claimed is:

1. A method comprising:
detecting, with a microphone of a first wearable head device, a sound of an environment;
determining a digital audio signal based on the detected sound, the digital audio signal associated with a sphere having a position in the environment;
concurrently with detecting the sound, detecting, via a sensor of the first wearable head device, a microphone movement with respect to the environment;
adjusting the digital audio signal, wherein the adjusting comprises adjusting the position of the sphere based on based on the detected microphone movement; and
presenting the adjusted digital audio signal to a user of a second wearable head device via one or more speakers of the second wearable head device.

2. The method of claim 1, further comprising:
detecting, with a microphone of a third wearable head device, a second sound of the environment;
determining a second digital audio signal based on the second sound, the second digital audio signal associated with a second sphere having a second position in the environment;
concurrently with detecting the second sound, detecting, via a sensor of the third wearable head device, a second microphone movement with respect to the environment;
adjusting the second digital audio signal, wherein the adjusting comprises adjusting the second position of the second sphere based on based on the second detected microphone movement;
combining the adjusted digital audio signal and the second adjusted digital audio signal; and
presenting the combined first adjusted digital audio signal and second adjusted digital audio signal to the user of the second wearable head device via the one or more speakers of the second wearable head device.

3. The method of claim 2, wherein the first adjusted digital audio signal and the second adjusted digital audio signal are combined at a server.

4. The method of claim 1, wherein the digital audio signal comprises an Ambisonic file.

5. The method of claim 1, wherein the detecting the microphone movement with respect to the environment comprises performing one or more of simultaneous localization and mapping and visual inertial odometry.

6. The method of claim 1, wherein the sensor comprises one or more of an inertial measurement unit, a camera, a second microphone, a gyroscope, and a LiDAR sensor.

7. The method of claim 1, wherein the adjusting the digital audio signal comprises applying a compensation function to the digital audio signal.

8. The method of claim 7, wherein the applying the compensation function comprises applying the compensation function based on an inverse of the microphone movement.

9. The method of claim 1, further comprising, concurrently with presenting the adjusted digital audio signal, displaying, on a display of the second wearable head device, content associated with the sound of the environment.

10. A method comprising:
receiving, at a wearable head device, a digital audio signal, the digital audio signal associated with a sphere having a position in the environment;
detecting, via a sensor of the wearable head device, a device movement with respect to the environment;
adjusting the digital audio signal, wherein the adjusting comprises adjusting the position of the sphere based on based on the detected device movement; and
presenting the adjusted digital audio signal to a user of the wearable head device via one or more speakers of the wearable head device.

11. A method comprising:
detecting sounds of an environment;
extracting a sound object from the detected sounds; and
combining the sound object and a residual,
wherein:
the sound object comprises a first portion of the detected sounds, the first portion meeting a sound object criterion, and
the residual comprises a second portion of the detected sounds, the second portion not meeting the sound object criterion.

12. A method, comprising:
detecting, via a sensor of a wearable head device, a movement of the wearable head device with respect to the environment;
adjusting a sound object, wherein the sound object is associated with a first sphere having a first position in the environment and wherein the adjusting comprises adjusting the first position of the first sphere based on based on the detected device movement;
adjusting a residual, wherein the residual is associated with a second sphere having a second position in the environment and wherein the adjusting comprises adjusting the second position of the second sphere based on based on the detected device movement;
mixing the adjusted sound object and the adjusted residual; and
presenting the mixed adjusted sound object and the adjusted residual to a user of the wearable head device via one or more speakers of the wearable head device.

13. A system comprising:
a first wearable head device comprising:
a microphone; and
a sensor; and
one or more processors configured to perform a method comprising:
detecting, with the microphone, a sound of an environment;
determining a digital audio signal based on the detected sound, the digital audio signal associated with a sphere having a position in the environment;
concurrently with detecting the sound, detecting, via the sensor, a microphone movement with respect to the environment;
adjusting the digital audio signal, wherein the adjusting comprises adjusting the position of the sphere based on based on the detected microphone movement; and
presenting the adjusted digital audio signal to a user of a second wearable head device via one or more speakers of the second wearable head device.

14. A non-transitory computer-readable medium storing one or more instructions, which, when executed by one or more processors of an electronic device, cause the electronic device to perform a method comprising:
detecting, with a microphone of a first wearable head device, a sound of an environment;
determining a digital audio signal based on the detected sound, the digital audio signal associated with a sphere having a position in the environment;
concurrently with detecting the sound, detecting, via a sensor of the first wearable head device, a microphone movement with respect to the environment;
adjusting the digital audio signal, wherein the adjusting comprises adjusting the position of the sphere based on based on the detected microphone movement; and
presenting the adjusted digital audio signal to a user of a second wearable head device via one or more speakers of the second wearable head device.

15. The system of claim 13, wherein the method further comprises:
detecting, with a microphone of a third wearable head device, a second sound of the environment;
determining a second digital audio signal based on the second sound, the second digital audio signal associated with a second sphere having a second position in the environment;
concurrently with detecting the second sound, detecting, via a sensor of the third wearable head device, a second microphone movement with respect to the environment;
adjusting the second digital audio signal, wherein the adjusting comprises adjusting the second position of the second sphere based on based on the second detected microphone movement;
combining the adjusted digital audio signal and the second adjusted digital audio signal; and
presenting the combined first adjusted digital audio signal and second adjusted digital audio signal to the user of the second wearable head device via the one or more speakers of the second wearable head device.

16. The system of claim 13, wherein the digital audio signal comprises an Ambisonic file.

17. The system of claim 13, wherein the detecting the microphone movement with respect to the environment comprises performing one or more of simultaneous localization and mapping and visual inertial odometry.

18. The system of claim 13, wherein the sensor comprises one or more of an inertial measurement unit, a camera, a second microphone, a gyroscope, and a LiDAR sensor.

19. The system of claim 13, wherein the adjusting the digital audio signal comprises applying a compensation function to the digital audio signal.

20. The system of claim 13, wherein the method further comprises, concurrently with presenting the adjusted digital audio signal, displaying, on a display of the second wearable head device, content associated with the sound of the environment.
